(19) United States
(12) Patent Application Publication
(10) Pub. No.: US 2025/0149748 A1
(43) Pub. Date: May 8, 2025

(54) CONNECTION MODULE SET, ELECTRODE CONNECTION MEMBER SET, AND BATTERY PACK

(71) Applicant: Yazaki Corporation, Tokyo (JP)

(72) Inventors: Hayato YAMAGUCHI, Makinohara-shi (JP); Sadaharu OKUDA, Makinohara-shi (JP); Hajime KATO, Makinohara-shi (JP)

(73) Assignee: Yazaki Corporation, Tokyo (JP)

(21) Appl. No.: 18/923,228

(22) Filed: Oct. 22, 2024

(30) Foreign Application Priority Data
Nov. 7, 2023 (JP) 2023-190252

(51) Int. Cl. H01M 50/507; H01M 50/517; H01M 50/526

(52) U.S. Cl. CPC H01M 50/507; H01M 50/517; H01M 50/526

(57) ABSTRACT

A connection module set according to an embodiment includes a first connection module and a second connection module. The first connection module includes a first electrode connection member. The first electrode connection member includes a basal end electrically connected to a first electrode terminal of the first battery module, and a protruding end protruding in a first direction. The second connection module includes a second electrode connection member. The second electrode connection member includes a basal end electrically connected to a second electrode terminal of the second battery module, and a holder into which the protruding end of the first electrode connection member of the first connection module is inserted from the first direction and held.

### BACKGROUND OF THE INVENTION

### Field of the Invention

Embodiments of the present invention relate to a connection module set, an electrode connection member set, and a battery pack.

Priority is claimed on Japanese Patent Application No. 2023-190252 filed in Japan on Nov. 7, 2023, the content of which is incorporated herein by reference.

### Description of the Related Art

A battery pack in which a plurality of battery modules are arranged side by side is known. In addition, as a structure for preventing corrosion of a surface of a bus bar, a structure has been proposed in which, in a metal clad material formed by joining a first metal plate formed of an aluminum plate and a second metal plate made of a metal different from the first metal plate, the first metal plate has a fitting groove, and the second metal plate has a fitting protrusion to be fitted into the fitting groove.
Patent Document 1: Japanese Unexamined Patent Application, First Publication No. 2021-82395
Patent Document 2: Japanese Unexamined Patent Application, First Publication No. 2015-187909

### SUMMARY OF THE INVENTION

Incidentally, in a case where electrodes of a plurality of battery modules are connected to each other by using a connection structure using bolt fastening, it may be difficult to improve assembling workability.

An embodiment of the present invention provides a connection module set, an electrode connection member set, and a battery pack suitable for improving assembling workability of the battery pack.

A connection module set according to an embodiment of the present invention is a member set used for a battery pack including a first battery module and a second battery module adjacent to the first battery module in a first direction. The connection module set includes a first connection module and a second connection module. The first connection module includes an insulating first substrate disposed to face an end of the first battery module in a second direction in a case where the second direction is a direction intersecting the first direction, and a first electrode connection member supported by the first substrate. The first electrode connection member includes a basal end electrically connected to a first electrode terminal of the first battery module, and a protruding end protruding in the first direction. The second connection module includes an insulating second substrate disposed to face the second end of the second battery module, and a second electrode connection member supported by the second substrate. The second electrode connection member includes a basal end electrically connected to a second electrode terminal of the second battery module, and a holder into which the protruding end of the first electrode connection member of the first connection module is inserted from the first direction and held.

An electrode connection member set according to an embodiment of the present invention is a member set used for a battery pack including a first battery module and a second battery module adjacent to the first battery module in a first direction. The electrode connection member set includes a first electrode connection member and a second electrode connection member. The first electrode connection member includes a basal end overlapping one end of the first battery module when viewed from a second direction in a case where the second direction is a direction intersecting the first direction, and electrically connected to a first electrode terminal of the first battery module, and a protruding end protruding in the first direction. The second electrode connection member includes a basal end overlapping one end of the second battery module when viewed from the second direction and electrically connected to a second electrode terminal of the second battery module, and a holder that has a portion elastically deformable in a direction intersecting the first direction and into which the protruding end of the first electrode connection member is inserted from the first direction and held.

A battery pack according to an embodiment of the present invention includes a first battery module, a second battery module, a first connection module, and a second connection module. The second battery module is adjacent to the first battery module in the first direction. The first connection module includes an insulating first substrate disposed to face an end of the first battery module in a second direction in a case where the second direction is a direction intersecting the first direction, and a first electrode connection member supported by the first substrate. The first electrode connection member includes a basal end electrically connected to a first electrode terminal of the first battery module, and a protruding end protruding in the first direction. The second connection module includes an insulating second substrate disposed to face the second end of the second battery module, and a second electrode connection member supported by the second substrate. The second electrode connection member includes a basal end electrically connected to a second electrode terminal of the second battery module, and a holder into which the protruding end of the first electrode connection member of the first connection module is inserted from the first direction and held.

According to an embodiment of the present invention, it is possible to provide a connection module set, an electrode connection member set, and a battery pack capable of improving assembling workability of the battery pack.

### BRIEF DESCRIPTION OF THE DRAWINGS

FIG. 1 is a perspective view illustrating an overall constitution of a battery pack of an embodiment.

FIG. 2 is an exploded perspective view illustrating a partial constitution of the battery pack of the embodiment.

FIG. 3 is a front view illustrating a battery module of the embodiment.

FIG. 4 is a cross-sectional view taken along line F4-F4 of the battery pack illustrated in FIG. 2.

FIG. 5 is a side view illustrating a wiring module of the embodiment.

FIG. 6 is a perspective view illustrating the wiring module of the embodiment.

FIG. 7 is a perspective view illustrating a wiring member, a thermistor, and a connector of the embodiment.

FIG. 8 is a perspective view for describing a connection structure of a terminal connection portion of the embodiment.

FIG. 9 is an electric circuit diagram illustrating a constitution of the wiring module of the embodiment.

FIG. 10 is a side view illustrating two wiring modules of the embodiment.

FIG. 11 is a perspective view illustrating a routing module of the embodiment.

FIG. 12 is an electric circuit diagram illustrating a constitution of a wiring module of a first modification example of the embodiment.

FIG. 13 is an electric circuit diagram illustrating a constitution of a wiring module of a second modification example of the embodiment.

FIG. 14 is a side view illustrating two wiring modules of a third modification example of the embodiment.

FIG. 15 is a side view illustrating two wiring modules of a fourth modification example of the embodiment.

### DETAILED DESCRIPTION OF THE INVENTION

Hereinafter, an embodiment will be described with reference to the drawings. In the following description, constitutions having the same or similar functions are denoted by the same reference numerals. Redundant descriptions of these constitutions may be omitted. In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “supported” is not limited to a case where an element is supported by being in direct contact, and may include a case where an element is supported with another element interposed therebetween.

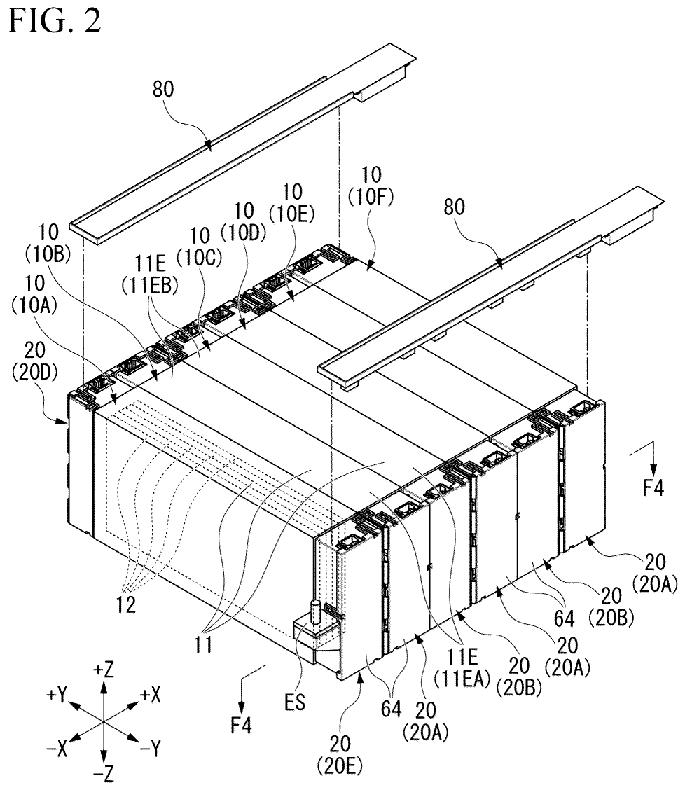

In the present disclosure, a +X direction, a −X direction, a +Y direction, a −Y direction, a +Z direction, and a −Z direction are defined as follows. The +X direction is a direction from a battery module 10A that will be described later to a battery module 10B (refer to FIG. 2). The −X direction is a direction opposite to the +X direction. In a case where the +X direction and the −X direction are not distinguished, they will be simply referred to as an “X direction”. The +Y direction and the −Y direction are directions intersecting (for example, orthogonal to) the X direction. The +Y direction is a direction from a first end 11EA to a second end 11EB of the battery module 10 that will be described later (refer to FIG. 2). The −Y direction is a direction opposite to the +Y direction. In a case where the +Y direction and the −Y direction are not distinguished, they will be simply referred to as a “Y direction”. The +Z direction is a direction intersecting (for example, orthogonal to) the X direction and the Y direction. The +Z direction is a direction from the battery module 10 toward a routing module 80 that will be described later (refer to FIG. 2). The −Z direction is a direction opposite to the +Z direction. In a case where the +Z direction and the −Z direction are not distinguished, they are simply referred to as “Z direction”. The X direction is an example of a “first direction”. The Y direction is an example of a “second direction”. The Z direction is an example of a “third direction”.

### Embodiment

### 1. Overall Constitution of Battery Pack

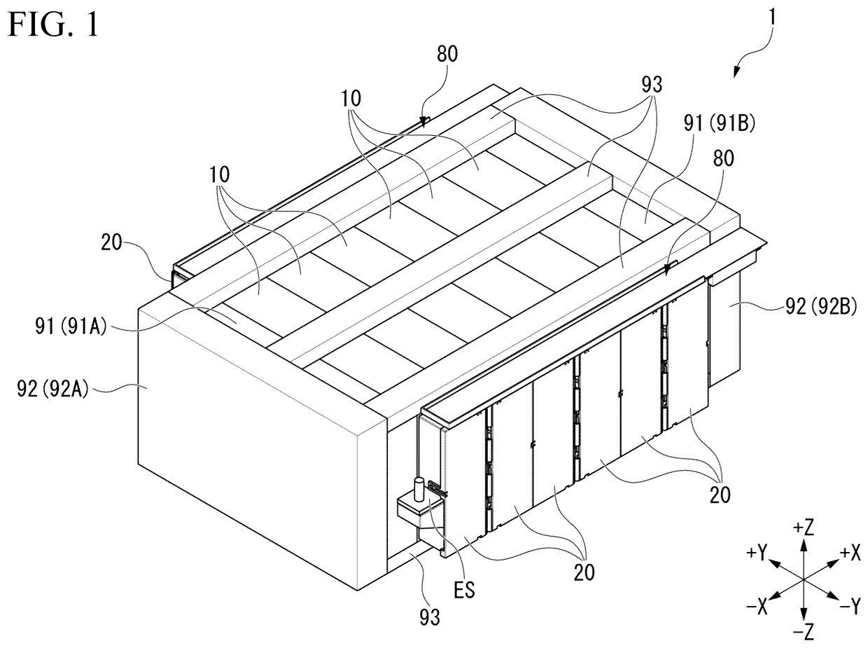

FIG. 1 is a perspective view illustrating an overall constitution of a battery pack 1 according to an embodiment. The battery pack 1 includes, for example, a plurality of battery modules 10, a plurality of wiring modules 20, two routing modules 80, two insulating members 91, two end plates 92, and a plurality of coupling members 93. The battery pack 1 may further include an outer member that houses these members.

### 2. Battery Module

First, the battery module 10 will be described.

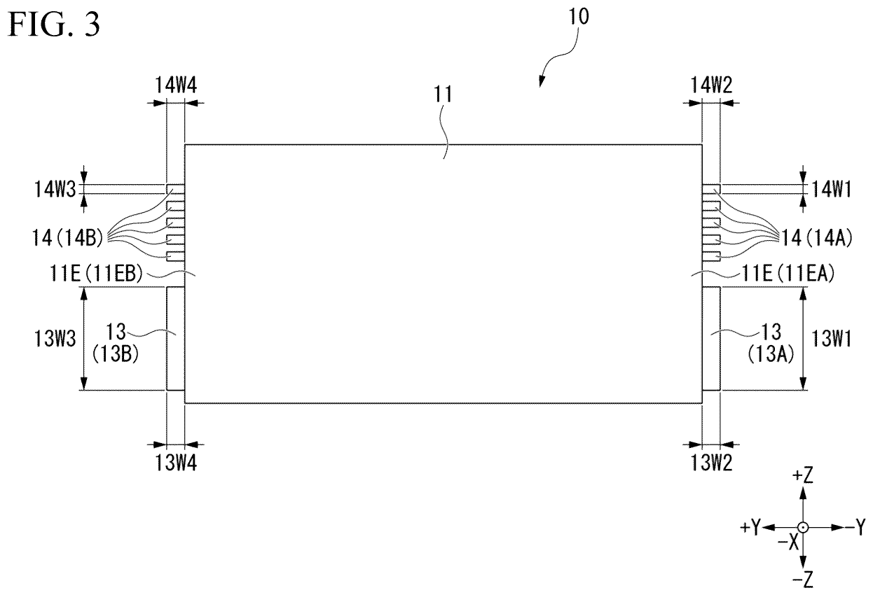

FIG. 2 is an exploded perspective view illustrating a partial constitution of the battery pack 1. The plurality of battery modules 10 are arranged side by side in the X direction. Each battery module 10 is a structure incorporating a plurality of battery cells 12. In the present embodiment, the battery module 10 is a bipolar battery module. Each battery module 10 includes, for example, a case 11, a plurality of battery cells 12, a positive electrode terminal 13A (refer to FIG. 3), a negative electrode terminal 13B (refer to FIG. 3), and a plurality of voltage detection terminals 14 (refer to FIG. 3).

### <2.1 Case>

The case 11 is a housing that houses the plurality of battery cells 12. The case 11 has a flat rectangular parallelepiped outer shape. The case 11 has six end surfaces. The case 11 is disposed such that an end surface (main surface) having the largest area among the six end surfaces is disposed in the Y direction and the Z direction. A longitudinal direction of the case 11 is, for example, the Y direction.

In the present embodiment, the case 11 has a first end 11EA and a second end 11EB as ends in the Y direction. The first end 11EA is an end on the −Y direction side. The first end 11EA is an example of “a first end of the battery module”. Hereinafter, for convenience of description, the first end 11EA of the case 11 may be referred to as “the first end 11EA of the battery module 10”. On the other hand, the second end 11EB is an end on the +Y direction side. The second end 11EB is an example of a “second end of the battery module”. Hereinafter, for convenience of description, the second end 11EB of the case 11 may be referred to as the “second end 11EB of the battery module 10”. Hereinafter, in a case where the first end 11EA and the second end 11EB are not distinguished, they will be simply referred to as an “end 11E”.

### <2.2 Battery Cell>

The plurality of battery cells 12 are built in the case 11. The plurality of battery cells 12 are arranged side by side in the X direction inside the case 11, for example. The plurality of battery cells 12 are electrically connected in series. In the present embodiment, two battery cells 12 adjacent to each other in the X direction share one current collector functioning as a bipolar electrode. Although five battery cells 12 are illustrated in FIG. 2 for convenience of description, more battery cells 12 may actually be disposed.

### <2.3 Positive Electrode Terminal>

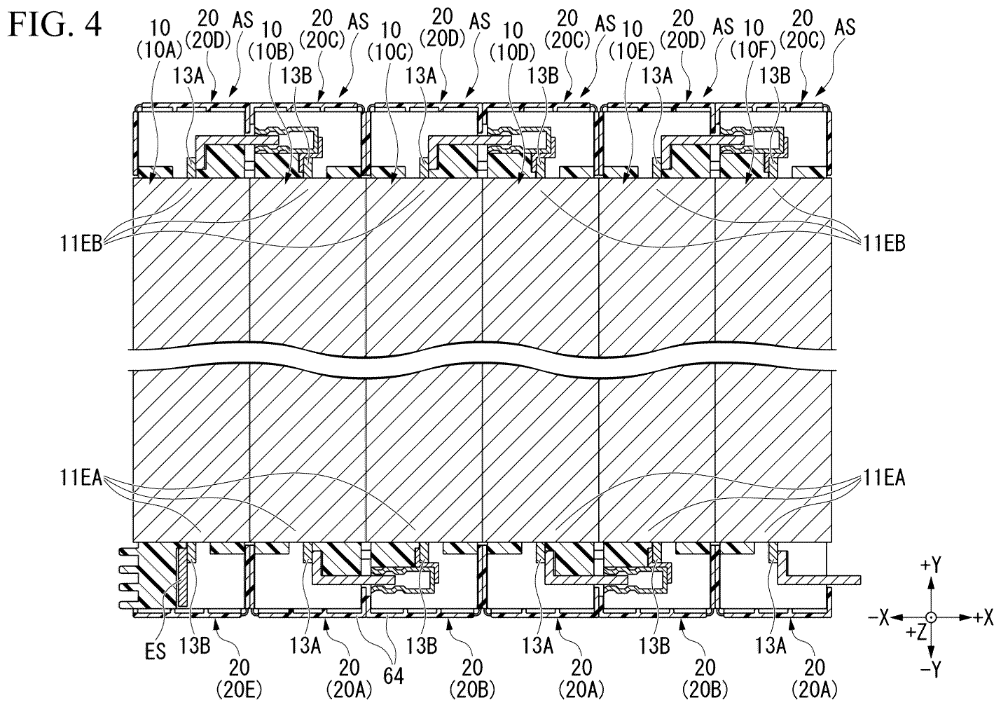

FIG. 3 is a front view illustrating the battery module 10. The positive electrode terminal 13A is a terminal on the positive side (total positive terminal) electrically connected in series to the plurality of battery cells 12 included in the battery module 10. The positive electrode terminal 13A is an example of a “first electrode terminal”. The positive electrode terminal 13A protrudes to the outside of the case 11 to be exposed to the outside of the battery module 10. The positive electrode terminal 13A protrudes in the Y direction from the first end 11EA or the second end 11EB of the case 11. For example, in the battery modules 10 (battery modules 10B, 10D, and 10F) located at the even-number positions when counted from the −X direction side, the positive electrode terminal 13A protrudes in the −Y direction from the first end 11EA of the case 11 (refer to FIG. 4). On the other hand, in the battery modules 10 (battery modules 10A, 10C, and 10E) located at the odd-numbered positions when counted from the −X direction side, the positive electrode terminal 13A protrudes in the +Y direction from the second end 11EB of the case 11 (refer to FIG. 4).

As illustrated in FIG. 3, the positive electrode terminal 13A has a plate shape extending along the Y direction and the Z direction. In the present embodiment, a width 13W1 of the positive electrode terminal 13A in the Z direction is larger than a width 13W2 of the positive electrode terminal 13A in the Y direction (that is, an amount of protrusion from the end 11E of the case 11 in the Y direction). For example, the width 13W1 of the positive electrode terminal 13A in the Z direction is twice or more the width 13W2 of the positive electrode terminal 13A in the Y direction.

### <2.4 Negative Electrode Terminal>

The negative electrode terminal 13B is a terminal on the negative side (total negative terminal) electrically connected in series to the plurality of battery cells 12 included in the battery module 10. The negative electrode terminal 13B is an example of a “second electrode terminal”. The negative electrode terminal 13B protrudes to the outside of the case 11 to be exposed to the outside of the battery module 10. The negative electrode terminal 13B protrudes in the Y direction from the first end 11EA or the second end 11EB of the case 11. For example, in the present embodiment, in the battery modules 10 (the battery modules 10B, 10D, and 10F) located at the even-numbered positions when counted from the −X direction side, the negative electrode terminal 13B protrudes in the +Y direction from the second end 11EB of the case 11 (refer to FIG. 4). On the other hand, in the battery modules 10 (the battery modules 10A, 10C, and 10E) located at the odd-numbered positions when counted from the −X direction side, the negative electrode terminal 13B protrudes in the −Y direction from the first end 11EA of the case 11 (refer to FIG. 4).

As illustrated in FIG. 3, the negative electrode terminal 13B has a plate shape extending along the Y direction and the Z direction. In the present embodiment, a width 13W3 of the negative electrode terminal 13B in the Z direction is larger than a width 13W4 of the negative electrode terminal 13B in the Y direction (that is, an amount of protrusion from the end 11E of the case 11 in the Y direction). For example, the width 13W3 of the negative electrode terminal 13B in the Z direction is twice or more the width 13W4 of the negative electrode terminal 13B in the Y direction. Hereinafter, in a case where the positive electrode terminal 13A and the negative electrode terminal 13B are not distinguished, they will be simply referred to as an “electrode terminal 13”.

### <2.5 Voltage Detection Terminal>

The voltage detection terminal 14 is a terminal for detecting a voltage related to the battery module 10 (for example, a voltage inside the battery module 10). For example, the voltage detection terminal 14 is a terminal for detecting a voltage between two adjacent battery cells 12 inside the battery module 10. For example, the voltage detection terminal 14 is electrically connected to a current collector (bipolar electrode) shared by two battery cells 12 adjacent in the X direction, and detects a voltage between the two battery cells 12. In the present embodiment, each battery module 10 has a plurality of (for example, ten) voltage detection terminals 14. The plurality of voltage detection terminals 14 are connected to different positions inside the battery module 10, and detect voltages between different sets of adjacent battery cells 12. The voltage detection terminal 14 is an example of a “detection terminal”. The “detection terminal” described in the present disclosure may be a terminal for detecting a physical quantity other than a voltage (for example, a current or a temperature).

Each of the plurality of voltage detection terminals 14 protrudes to the outside of the case 11 to be exposed to the outside of the battery module 10. In the present embodiment, the plurality of voltage detection terminals 14 include a plurality of (for example, five) voltage detection terminals 14A of a first group and a plurality of (for example, five) voltage detection terminals 14B of a second group. The plurality of voltage detection terminals 14A of the first group protrude in the −Y direction from the first end 11EA of the case 11. The plurality of voltage detection terminals 14A of the first group are arranged side by side in the Z direction and separated from each other in the Z direction. The plurality of voltage detection terminals 14A of the first group include three or more detection terminals disposed in parallel to each other. Each of the plurality of voltage detection terminals 14A of the first group has a plate shape extending along the Y direction and the Z direction. In the present embodiment, a width 14W2 of the voltage detection terminal 14A in the Y direction (that is, an amount of protrusion in the Y direction from the end 11E of the case 11) is larger than a width 14W1 of the voltage detection terminal 14A in the Z direction.

On the other hand, the plurality of voltage detection terminals 14B of the second group protrude in the +Y direction from the second end 11EB of the case 11. The plurality of voltage detection terminals 14B of the second group are arranged side by side in the Z direction and separated from each other in the Z direction. The plurality of voltage detection terminals 14B of the second group include three or more detection terminals disposed in parallel to each other. Each of the plurality of voltage detection terminals 14B of the second group has a plate shape extending along the Y direction and the Z direction. In the present embodiment, a width 14W4 of the voltage detection terminal 14B in the Y direction (that is, an amount of protrusion in the Y direction from the end 11E of the case 11) is larger than a width 14W3 of the voltage detection terminal 14B in the Z direction.

### 3. Wiring Module

Next, the wiring module 20 will be described.

The wiring module 20 is, for example, a relay member for transmitting a signal obtained from the detection terminal of the battery module 10 to the outside. In the present embodiment, the wiring module 20 is a relay member that electrically connects the detection terminal of the battery module 10 to the routing module 80 that will be described later. From another point of view, the wiring module 20 is a member for connecting the electrode terminal 13 of the battery module 10 to the electrode terminal 13 of another battery module 10. The wiring module 20 is an example of a “connection module”.

FIG. 4 is a cross-sectional view taken along line F4-F4 of the battery pack 1 illustrated in FIG. 2. In the present embodiment, the battery pack 1 includes, for example, five types of wiring modules 20A, 20B, 20C, 20D, 20E as the wiring modules 20. The wiring module 20A and the wiring module 20C are disposed to correspond to the battery module 10 (for example, the battery modules 10B, 10D, and 10F) located at the even-numbered positions when counted from the −X direction side. The wiring module 20A is disposed on the −Y direction side of the battery module 10. The wiring module 20C is disposed on the +Y direction side of the battery module 10. On the other hand, the wiring module 20B and the wiring module 20D are disposed to correspond to the battery modules 10 (for example, the battery modules 10C and 10E) located at the odd-numbered positions when counted from the −X direction side. The wiring module 20B is disposed on the −Y direction side of the battery module 10. The wiring module 20D is disposed on the +Y direction side of the battery module 10. The wiring module 20E is disposed to correspond to the battery module 10 (for example, the battery module 10A) on the most −X direction side, for example.

Here, first, one wiring module 20A will be taken as an example, and a constitution common to the wiring modules 20A, 20B, 20C, 20D, and 20E will be described. Note that, regarding the common constitution, the wiring module 20B may be described in detail by replacing “−X direction” and “+X direction” in the description of the wiring module 20A described below. Similarly, details of the wiring module 20C may be understood by replacing “−Y direction” with “+Y direction”, replacing “first end 11EA” and “second end 11EB”, and replacing “−X direction” with “+X direction”. Similarly to the description of the wiring module 20A described below, details of the wiring module 20D may be understood by replacing “−Y direction” with “+Y direction” and replacing “first end 11EA” with “second end 11EB” in the description of the wiring module 20A described below. The wiring module 20E will be described later.

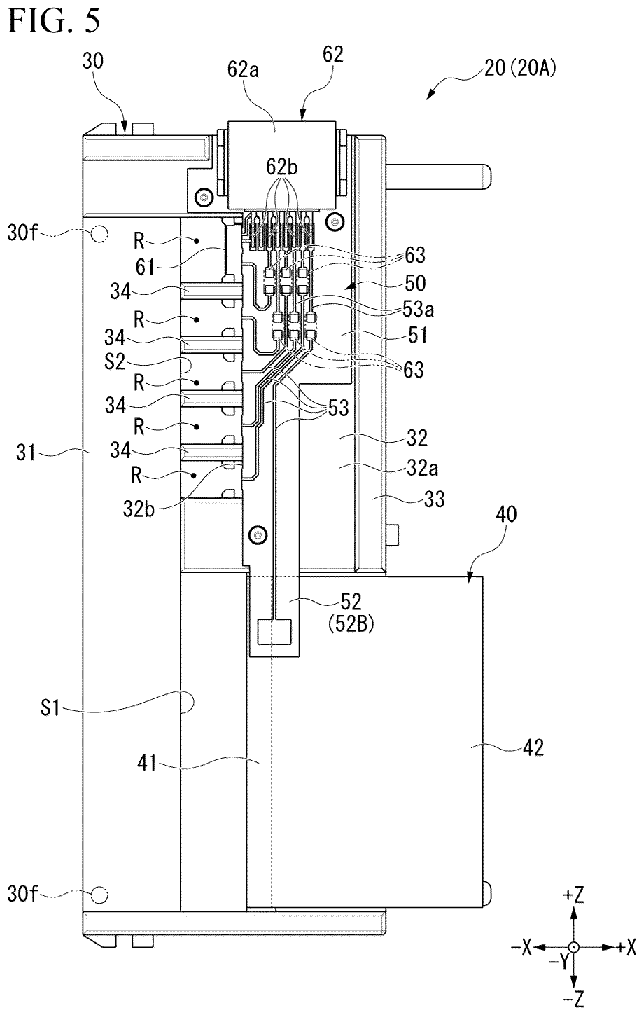

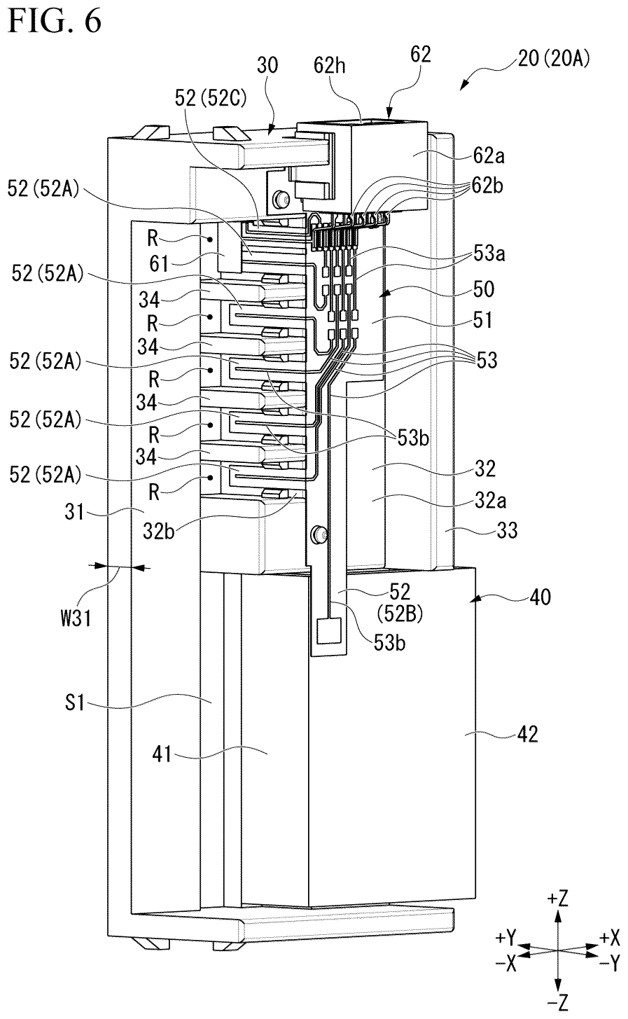

FIG. 5 is a side view illustrating one wiring module 20 (for example, the wiring module 20A). FIG. 6 is a perspective view illustrating one wiring module 20 (for example, the wiring module 20A). The wiring module 20 includes, for example, a substrate 30, an electrode connection member 40, a wiring member 50, a thermistor 61, a connector 62, a plurality of fuse components 63 (refer to FIG. 5), and a cover 64 (refer to FIG. 2).

### <3.1 Substrate>

The substrate 30 is a member serving as a base of the wiring module 20. The substrate 30 is made of an insulating material such as a synthetic resin and has an insulating property. The substrate 30 is disposed to face the end 11E of the battery module 10. For example, the substrate 30 faces the first end 11EA of the battery module 10 from the −Y direction.

The substrate 30 is attached to the end 11E of the battery module 10 by using, for example, a fixer 30f. The fixer 30f is, for example, a fastening member such as a bolt, but may have an engagement structure or the like, and is not limited to a specific structure. When the substrate 30 is attached to the end 11E of the battery module 10, the wiring module 20 and the battery module 10 are integrated. In the present embodiment, before the plurality of battery modules 10 are arranged side by side, the wiring module 20 is attached to each battery module 10, and a battery module assembly AS (refer to FIG. 4) is formed. Each battery module assembly AS includes one battery module 10 and two wiring modules 20 disposed separately on both sides in the Y direction of the battery module 10.

As illustrated in FIGS. 5 and 6, the substrate 30 includes, for example, a first portion 31, a second portion 32, a protruding wall 33, and a plurality of partition walls 34.

The first portion 31 is a thin plate extending in the Z direction along the end 11E of the battery module 10. The first portion 31 extends over most of the battery module 10 in the Z direction. A thickness W31 of the first portion 31 in the Y direction is smaller than a width (for example, the width 13W2; refer to FIG. 3) of the electrode terminal 13 in the Y direction and smaller than a width (for example, the width 14W2; refer to FIG. 3) of the voltage detection terminal 14 in the Y direction. When viewed from the −X direction side in a state in which the wiring module 20 is attached to the battery module 10, the distal end of each of the electrode terminal 13 and the plurality of voltage detection terminals 14 is exposed on the −X direction side without overlapping the first portion 31.

The second portion 32 is a thick plate extending in the Z direction along the end 11E of the battery module 10. The second portion 32 is located away from the first portion 31 on the +X direction side. The second portion 32 extends in the Z direction in parallel to the first portion 31. A thickness of the second portion 32 in the Y direction is larger than a width (for example, the width 13W2; refer to FIG. 3) of the electrode terminal 13 in the Y direction and larger than a width (for example, the W14W2; refer to FIG. 3) of the voltage detection terminal 14 in the Y direction.

The second portion 32 has a first surface 32a and a second surface 32b. The first surface 32a is a plane extending along the X direction and the Z direction. The first surface 32a is a surface to which a main body 51 of the wiring member 50 that will be described later is attached. The second surface 32b is a plane extending along the Y direction and the Z direction. For example, the second surface 32b extends in the +Y direction from the end of the first surface 32a on the −X direction side. The second surface 32b is a surface facing a second space S2 that will be described later.

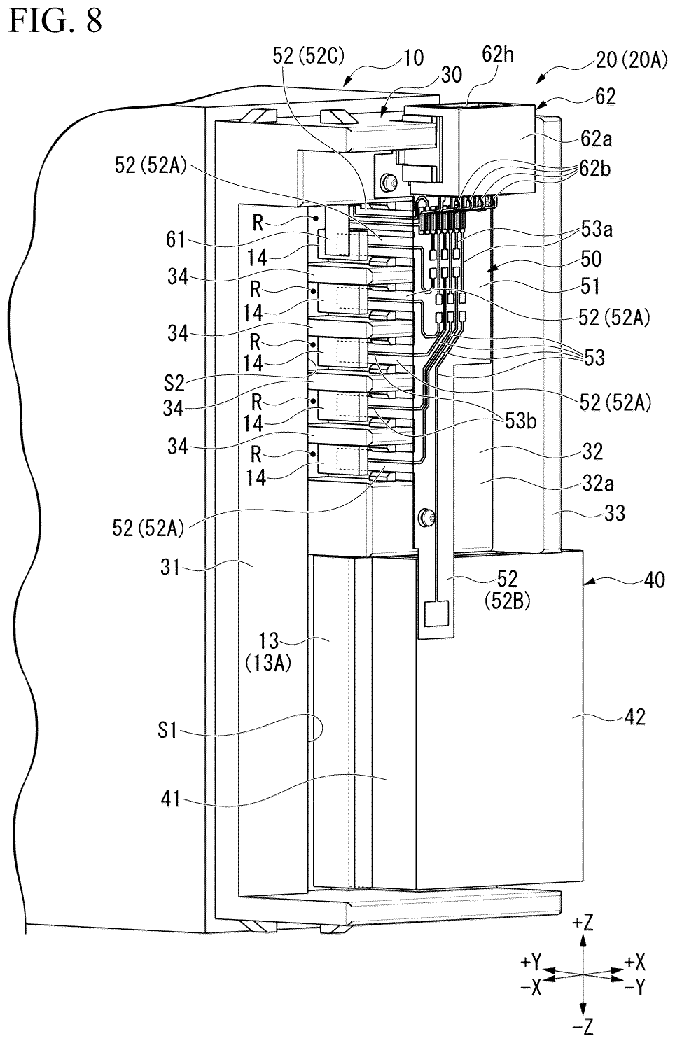

In the present embodiment, a first space S1 and the second space S2 are provided between the first portion 31 and the second portion 32. The first space S1 is provided at a position corresponding to the electrode terminal 13 of the battery module 10. In a case where the wiring module 20 is attached to the battery module 10, the electrode terminal 13 of the battery module 10 is inserted into the first space S1 (refer to FIG. 8).

The second space S2 is provided at a position corresponding to the plurality of voltage detection terminals 14 of the battery module 10. In a case where the wiring module 20 is attached to the battery module 10, the plurality of voltage detection terminals 14 of the battery module 10 are inserted into the second space S2 (refer to FIG. 8). The second surface 32b of the second portion 32 faces the second space S2 from the +X direction side.

The protruding wall 33 is a portion protruding in the −Y direction as compared with the second portion 32 of the substrate 30. The protruding wall 33 is disposed adjacent to the second portion 32 of the substrate 30 from the +X direction side. The protruding wall 33 extends linearly in the −Z direction in parallel to the second portion 32. The protruding wall 33 is an insulating wall that covers the wiring member 50 and the connector 62 that will be described later from the +X direction side.

The plurality of partition walls 34 are disposed between the first portion 31 and the second portion 32 of the substrate 30. The plurality of partition walls 34 are arranged side by side in the Z direction and separated from each other in the Z direction. Each of the partition walls 34 extends in the X direction and the Y direction. Each of the partition walls 34 is connected to the first portion 31 and the second portion 32 of the substrate 30. The plurality of partition walls 34 are insulating walls provided in the second space S2.

The plurality of partition walls 34 divide the second space S2 into a plurality of regions R. The plurality of regions R are arranged side by side in the Z direction in a state of being electrically insulated from each other. The plurality of regions R are provided at positions corresponding to the plurality of voltage detection terminals 14 of the battery module 10 on a one-to-one basis. In a case where the wiring module 20 is attached to the battery module 10, the voltage detection terminal 14 of the battery module 10 is inserted into each region R (refer to FIG. 8). The plurality of partition walls 34 electrically insulate the plurality of voltage detection terminals 14 of the battery module 10 inserted into the second space S2 from each other.

### <3.2 Electrode Connection Member>

The electrode connection member 40 is a member for connecting the electrode terminal 13 of the battery module 10 to the electrode terminal 13 of another battery module 10. The electrode connection member 40 is attached to the second portion 32 of the substrate 30 by, for example, a fixer (not illustrated). The electrode connection member 40 is supported by the second portion 32 of the substrate 30. The electrode connection member 40 has a basal end 41 connected to the electrode terminal 13 of the battery module 10 and a distal end 42 connected to the electrode connection member 40 provided in another wiring module 20.

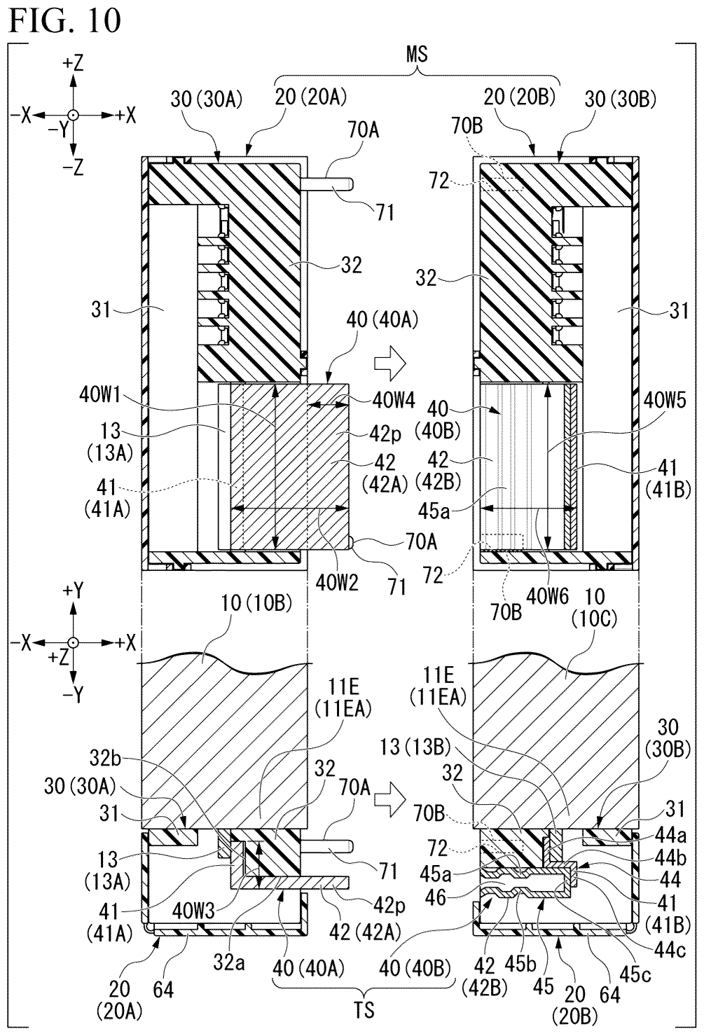

The basal end 41 of the electrode connection member 40 is disposed, for example, along the second surface 32b of the second portion 32 of the substrate 30 (refer to FIG. 10). The basal end 41 faces the electrode terminal 13 of the battery module 10 inserted into the first space S1 from the +X direction side. The basal end 41 is joined to the electrode terminal 13 of the battery module 10 through, for example, metal joining. The metal joining is realized, for example, by performing laser welding or the like from the −X direction side in a state in which the basal end 41 of the electrode connection member 40 and the electrode terminal 13 overlap each other when viewed from the −X direction. However, a method for joining the basal end 41 of the electrode connection member 40 and the electrode terminal 13 is not limited to the above example.

The distal end 42 of the electrode connection member 40 extends in the X direction from the basal end 41. The distal end 42 of the electrode connection member 40 will be described later in detail.

In the present embodiment, the electrode connection member 40 is also used as a terminal for detecting a voltage of the electrode terminal 13. The electrode connection member 40 is an example of a “detection terminal”. In the present disclosure, the “detection terminal” is not limited to a terminal dedicated to detection, but broadly means a terminal that can be used for detection.

### <3.3 Wiring Member>

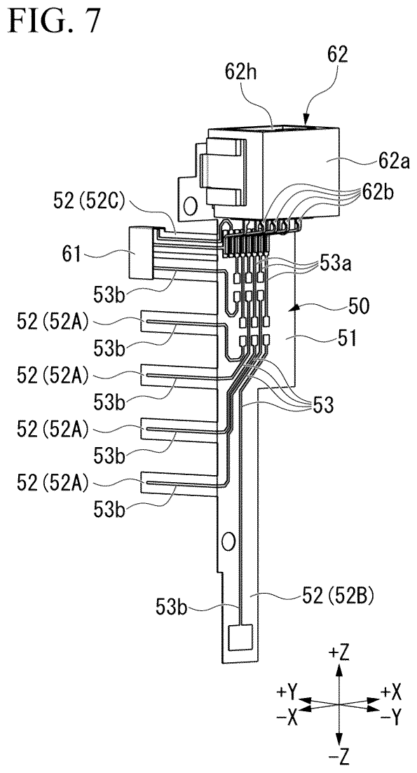

FIG. 7 is a perspective view illustrating the wiring member 50, the thermistor 61, and the connector 62. The wiring member 50 is a member having a wiring 53 for transmitting a signal obtained from the detection terminal of battery module 10 to the outside. The wiring member 50 is, for example, a flat wiring member. In the present disclosure, the “flat wiring member” broadly means a member including an insulating base material having flexibility and a wiring (conductive pattern) provided on the insulating base material. The flat wiring member is a flexible flat cable (FFC), a flexible printed circuit (FPC), or the like.

In the present embodiment, the wiring member 50 includes a main body 51 and a plurality of connection portions 52. The wiring member 50 includes a plurality of wirings 53. The wirings 53 extend over the main body 51 and the respective connection portions 52.

The main body 51 has a film shape extending along the X direction and the Z direction. The main body 51 is disposed to face the substrate 30 from the Y direction. The main body 51 is attached to the first surface 32a of the second portion 32 of the substrate 30 by a fixer (for example, an adhesive) (not illustrated) or the like (refer to FIG. 6). The main body 51 is supported by the first surface 32a of the second portion 32 of the substrate 30.

The plurality of connection portions 52 include, for example, a plurality of (for example, five) terminal connection portions 52A for voltage detection terminals, a terminal connection portion 52B for an electrode terminal, and a thermistor connection portion 52C.

### (Terminal Connection Portion for Voltage Detection Terminal)

The plurality of terminal connection portions 52A mutually branch and extend from the main body 51. Each of the plurality of terminal connection portions 52A has a film shape extending along the Y direction and the Z direction. The plurality of terminal connection portions 52A are formed, for example, by bending a part of the wiring member 50 from the main body 51. The plurality of terminal connection portions 52A are disposed along the second surface 32b of the second portion 32 of the substrate 30. The plurality of terminal connection portions 52A may be attached to the second surface 32b of the second portion 32 of the substrate 30 by a fixer (for example, an adhesive) (not illustrated) or the like.

The plurality of terminal connection portions 52A are separated from each other in the Z direction. The plurality of terminal connection portions 52A include, for example, three or more terminal connection portions 52A disposed in parallel to each other. The plurality of terminal connection portions 52A extend separately inside the plurality of regions R defined by the plurality of partition walls 34 described above. That is, the plurality of terminal connection portions 52A are respectively inserted into the different regions R. The partition wall 34 is located between the plurality of terminal connection portions 52A.

FIG. 8 is a perspective view for describing a connection structure of the terminal connection portion 52A. The plurality of terminal connection portions 52A are respectively connected to the plurality of voltage detection terminals 14 of the battery module 10. For example, each of the plurality of terminal connection portions 52A faces the voltage detection terminal 14 inserted into the region R from the +X direction in the region R into which the terminal connection portion 52A is inserted. In the present embodiment, the plurality of terminal connection portions 52A are bent from the main body 51 and face the plurality of voltage detection terminals 14.

The terminal connection portion 52A is joined to the voltage detection terminal 14 through, for example, metal joining. The metal joining is realized, for example, by performing laser welding or the like from the −X direction side in a state in which the terminal connection portion 52A and the voltage detection terminal 14 overlap each other when viewed from the −X direction. However, a method of joining the terminal connection portion 52A to the voltage detection terminal 14 is not limited to the above example.

### (Terminal Connection Portion for Electrode Terminal)

The terminal connection portion 52B is a terminal connection portion for detecting a voltage of the electrode terminal 13 (a voltage of power output from the battery module 10). The terminal connection portion 52B is maintained in the same posture as that of the main body 51 and extends in the −Z direction from the main body 51. The terminal connection portion 52B has a film shape extending along the X direction and the Z direction. The terminal connection portion 52B overlaps the electrode connection member 40 when viewed from the Y direction. Similarly to the terminal connection portion 52A, the terminal connection portion 52B is joined to the electrode connection member 40 through, for example, metal joining. However, a method for joining the terminal connection portion 52B to the electrode connection member 40 is not limited to the above example.

### (Thermistor Connection Portion)

The thermistor connection portion 52C branches and extends from the main body 51 together with the plurality of terminal connection portions 52A. The thermistor connection portion 52C has a film shape extending along the Y direction and the Z direction. The thermistor connection portion 52C is formed, for example, by bending a part of the wiring member 50 from the main body 51. The thermistor connection portion 52C is disposed along the second surface 32b of the second portion 32 of the substrate 30. The thermistor connection portion 52C may be attached to the second surface 32b of the second portion 32 of the substrate 30 by a fixer (for example, an adhesive) (not illustrated) or the like. The thermistor connection portion 52C is disposed at a position different from the plurality of terminal connection portions 52A in the Z direction. The thermistor connection portion 52C is connected to the thermistor 61 that will be described later.

### <3.4 Thermistor>

The thermistor 61 is a component that detects a temperature related to the battery module 10. The thermistor 61 is provided inside the wiring module 20. In the present embodiment, the thermistor 61 is connected to one voltage detection terminal 14. For example, the thermistor 61 faces the voltage detection terminal 14 from the −X direction side. The thermistor 61 faces the voltage detection terminal 14 from the side opposite to the terminal connection portion 52A. The thermistor 61 is joined to the voltage detection terminal 14 through, for example, metal joining together with the terminal connection portion 52A. However, a method of joining the thermistor 61 to the voltage detection terminal 14 is not limited to the above example.

### <3.5 Connector>

The connector 62 is a connection portion that electrically connects the wiring module 20 and the routing module 80 in a detachable manner. The connector 62 is provided, for example, at the end of the wiring module 20 in the +Z direction. The connector 62 is supported by the substrate 30. For example, the connector 62 is placed on the main body 51 of the wiring member 50 and supported by the substrate 30 via the wiring member 50. The connector 62 is connected to the main body 51 of the wiring member 50.

The connector 62 includes a connector body 62a and a plurality of terminals 62b. The connector body 62a has an opening 62h that is open in the +Z direction and a plurality of terminals (not illustrated) provided inside the opening 62h. The plurality of terminals 62b are provided between the connector body 62a and the wiring member 50. The plurality of terminals 62b are connected to the plurality of wirings 53 of the wiring member 50. In the present embodiment, the plurality of terminals 62b correspond to the plurality of wirings 53 of the wiring member 50 on a one-to-one basis.

### <3.6 Fuse Component>

The fuse component 63 is provided in the main body 51 of the wiring member 50 (refer to FIG. 5). The fuse component 63 is, for example, a surface mount type chip fuse. The fuse component 63 is provided in the middle of each wiring 53 in the main body 51 of the wiring member 50. For example, each wiring 53 includes a first portion 53a connected to the connector 62 and a second portion 53b provided in the connection portion 52. The first portion 53a and the second portion 53b are provided apart from each other. The fuse component 63 is electrically connected in series between the first portion 53a and the second portion 53b. In a case where an excessive current flows through the wiring 53 provided with the fuse component 63, the fuse component 63 is blown to cut connection between the first portion 53a and the second portion 53b. For example, the fuse component 63 is provided in the main body 51 of the wiring member 50.

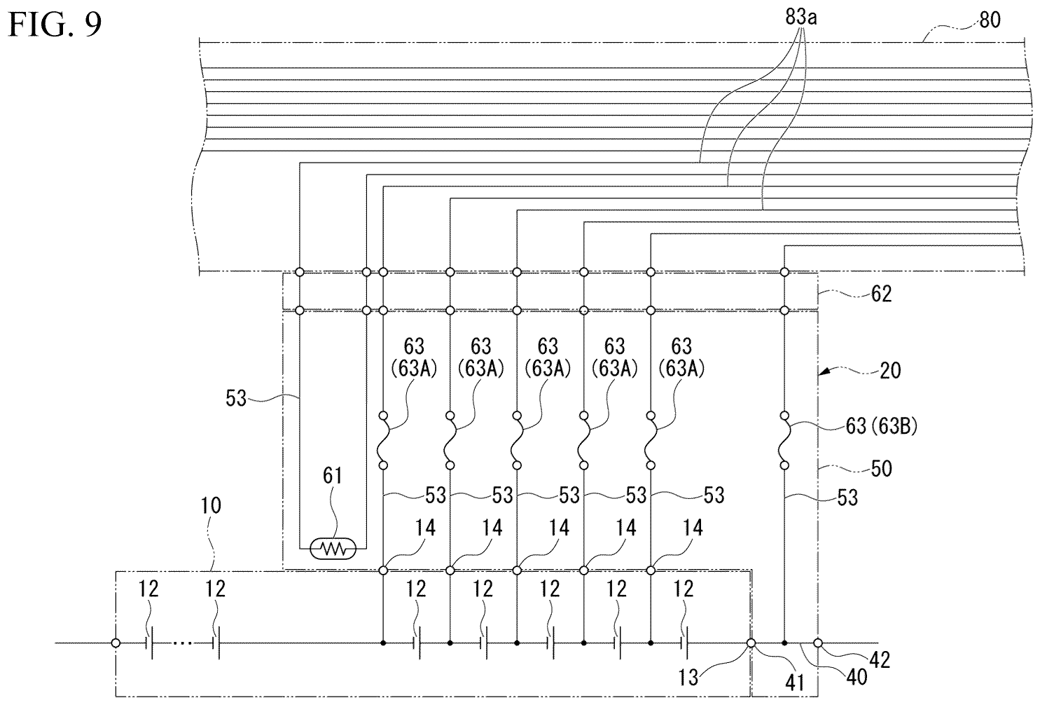

FIG. 9 is an electric circuit diagram illustrating a constitution of the wiring module 20 according to the embodiment. In the present embodiment, the plurality of fuse components 63 includes a plurality of (for example, five) fuse components 63A and one fuse component 63B. The plurality of fuse components 63A are electrically disposed in parallel to each other. Each of the plurality of fuse components 63A is electrically connected between one voltage detection terminal 14 included in the plurality of voltage detection terminals 14 and the connector 62. On the other hand, the fuse component 63B is electrically connected between the electrode connection member 40 and the connector 62. The fuse component 63 is a component used in association with the battery module 10. The fuse component 63 is an example of an “electronic component”.

### <3.7 Cover>

Referring to FIG. 2 again, the cover 64 will be described. The cover 64 is a member forming a part of an outer shell of the wiring module 20. The cover 64 covers the substrate 30, the electrode connection member 40, the wiring member 50, the thermistor 61, the connector 62, and the plurality of fuse components 63 from the −Y direction side.

### 4. Structure of Electrode Connection Member

Next, a connection structure between the plurality of wiring modules 20 will be described.

FIG. 10 is a side view illustrating one wiring module 20A and another wiring module 20B. Hereinafter, for convenience of description, the wiring module 20A will be referred to as a “first wiring module 20A”. The wiring module 20B will be referred to as a “second wiring module 20B”.

The first wiring module 20A is an example of a “first connection module”. The electrode terminal 13 (for example, the positive electrode terminal 13A) of the first wiring module 20A is an example of a “first electrode terminal”. The battery module 10 to which first wiring module 20A is attached is an example of a “first battery module”.

The second wiring module 20B is an example of a “second connection module”. The electrode terminal 13 (for example, the negative electrode terminal 13B) of the second wiring module 20B is an example of a “second electrode terminal”. The battery module 10 to which the second wiring module 20B is attached is an example of a “second battery module”. In the present embodiment, an example of a connection module set MS is formed by the first wiring module 20A and the second wiring module 20B.

### (First Wiring Module)

First, the first wiring module 20A will be described. The first wiring module 20A includes a first substrate 30A as the substrate 30. The first wiring module 20A includes a first electrode connection member 40A as the electrode connection member 40. The first electrode connection member 40A is, for example, a male engaging member. The first electrode connection member 40A is made of metal. The first electrode connection member 40A has a basal end 41A connected to the electrode terminal 13 of the first battery module 10 and a distal end 42A physically and electrically connected to the electrode connection member 40 of the second wiring module 20B.

The basal end 41A includes a plate extending along the Y direction and the Z direction. The basal end 41A overlaps the first end 11EA of the first battery module 10 when viewed from the Y direction. The basal end 41A faces the electrode terminal 13 (for example, the positive electrode terminal 13A) of the first battery module 10 from the +X direction side. The distal end 42A protrudes in the +X direction from the end of the basal end 41A on the −Y direction side. The distal end 42A includes a plate 42p extending along the X direction and the Z direction. For example, the distal end 42A protrudes to the +X direction side beyond the end surface on the +X direction side of the case 11 of the first wiring module 20A. The distal end 42A is an example of a “protruding end”.

In the present embodiment, a width 40W1 of the first electrode connection member 40A in the Z direction is larger than a width 40W2 of the first electrode connection member 40A in the X direction and larger than a width 40W3 of the first electrode connection member 40A in the Y direction. The width 40W1 of the first electrode connection member 40A in the Z direction is larger than a protrusion amount 40W4 of the first electrode connection member 40A from the end surface of the first substrate 30A on the +X direction side. For example, the width 40W1 of the first electrode connection member 40A in the Z direction is twice or more the protrusion amount 40W4 of the first electrode connection member 40A. For example, the width 40W1 of the first electrode connection member 40A in the Z direction is equal to the width 13W1 (or the width 13W3) of the electrode terminal 13 of the battery module 10 in the Z direction.

In the present embodiment, the first substrate 30A of the first wiring module 20A has a first engagement 70A. The first engagement 70A includes, for example, a protrusion 71 protruding in the +X direction. The protrusion 71 is, for example, a pin protruding linearly in the +X direction.

### (Second Wiring Module)

Next, the second wiring module 20B will be described. The second wiring module 20B includes a second substrate 30B as the substrate 30. The second wiring module 20B includes a second electrode connection member 40B as the electrode connection member 40. The second electrode connection member 40B is, for example, a female engaging member. The second electrode connection member 40B is made of metal. The second electrode connection member 40B has a basal end 41B connected to the electrode terminal 13 of the second battery module 10 and a distal end 42B physically and electrically connected to the electrode connection member 40 (first electrode connection member 40A) of the first battery module 10.

The basal end 41B includes a plate extending along the Y direction and the Z direction. The basal end 41B faces the electrode terminal 13 (for example, the negative electrode terminal 13B) of the second battery module 10 from the −X direction side. The distal end 42B extends in the −X direction from the basal end 41B. The distal end 42B includes a space into which the distal end 42A (protruding end) of the first wiring module 20A is inserted in the X direction. The distal end 42B holds the inserted distal end 42A (protruding end) of the first wiring module 20A. The distal end 42B is an example of a “holder”.

Hereinafter, an example of the second electrode connection member 40B will be described.

In the present embodiment, the distal end 42B includes a support member 44. The support member 44 is a member that supports a leaf spring member 45 that will be described later. The support member 44 includes, for example, a first portion 44a, a second portion 44b, and a third portion 44c.

The first portion 44a is a plate extending along the Y direction and the Z direction. The first portion 44a faces the electrode terminal 13 (for example, the negative electrode terminal 13B) of the second battery module 10 from the −X direction side. The first portion 44a is joined to the electrode terminal 13 of the second battery module 10. The first portion 44a is physically and electrically connected to the electrode terminal 13 of the second battery module 10.

The second portion 44b is a plate extending along the X direction and the Z direction. The second portion 44b extends in the +X direction from the end of the first portion 44a on the −Y direction side. In the present embodiment, the second portion 44b extends toward the +X direction side beyond the electrode terminal 13 of the second battery module 10. The third portion 44c is a plate extending along the Y direction and the Z direction. The third portion 44c extends in the −Y direction from the end of the second portion 44b on the +X direction side. The third portion 44c is located toward the +X direction side with respect to the electrode terminal 13 of the second battery module 10.

In the present embodiment, the distal end 42B includes a leaf spring member 45. The leaf spring member 45 is joined to the support member 44 and supported by the support member 44. The leaf spring member 45 includes, for example, a pair of clamps 45a and 45b, a base 45c, and an insertion space 46.

The base 45c is located at the end of the leaf spring member 45 on the +X direction side. The base 45c extends in the Y direction and the Z direction. The clamps 45a and 45b extend in the −X direction from both ends of the base 45c in the Y direction. The clamps 45a and 45b are disposed apart from each other in the Y direction. The end of each of the clamps 45a and 45b on the +X direction side is supported by the base 45c. The clamps 45a and 45b are elastically deformable in the Y direction. For example, the clamps 45a and 45b are elastically deformable with respect to the base 45c. The insertion space 46 exists between the clamps 45a and 45b.

In the present embodiment, in a case where the first wiring module 20A and the second wiring module 20B are connected, the distal end 42A (protruding end) of the first wiring module 20A is inserted between the clamps 45a and 45b of the second wiring module 20B. The distal end 42A of the first wiring module 20A is press-fitted toward an innermost of the insertion space 46 while elastically deforming the clamps 45a and 45b to widen a gap (insertion space 46) between the clamps 45a and 45b in the Y direction.

In this case, the distal end 42A of the first electrode connection member 40A is pressed from both sides in the Y direction by the clamps 45a and 45b. Consequently, the first electrode connection member 40A and the second electrode connection member 40B are physically and electrically connected to each other. That is, the first wiring module 20A and the second wiring module 20B are physically and electrically connected. In the present embodiment, the plate 42p of the distal end 42A of the first wiring module 20A is clamped from both sides in the Y direction by the clamps 45a and 45b. In the present embodiment, an example of an electrode connection member set TS is formed by the first electrode connection member 40A and the second electrode connection member 40B.

In the present embodiment, the leaf spring member 45 is joined to the second portion 44b and the third portion 44c of the support member 44, and is supported by the second portion 44b and the third portion 44c of the support member 44. In the present embodiment, the base 45c of the leaf spring member 45 is located toward the +X direction side with respect to the electrode terminal 13 of the second battery module 10. The clamps 45a and 45b extend from the base 45c beyond the electrode terminal 13 of the second battery module 10 in the −X direction. The clamps 45a and 45b extending long as described above are more likely to be elastically deformed in the Y direction than clamps extending short.

In the present embodiment, a width 40W5 of the second electrode connection member 40B in the Z direction is larger than a width 40W6 of the second electrode connection member 40B in the X direction. For example, the width 40W5 of the second electrode connection member 40B in the Z direction is equal to the width 13W1 (or width 13W3) of the electrode terminal 13 of the battery module 10 in the Z direction.

In the present embodiment, the second substrate 30B of the second wiring module 20B has a second engagement 70B. The second engagement 70B includes, for example, an engagement hole 72 recessed in the +X direction. The protrusion 71 of the first wiring module 20A is inserted into and engaged with (for example, fitted to) the engagement hole 72.

The disposition of the positive electrode terminal 13A and the negative electrode terminal 13B may be opposite to that in the above example. That is, the basal end 41A of the first wiring module 20A may be connected to the negative electrode terminal 13B of the first battery module 10, and the basal end 41B of the second wiring module 20B may be connected to the positive electrode terminal 13A of the second battery module 10. The disposition of the first electrode connection member 40A and the second electrode connection member 40B may be opposite to that in the above example. That is, the first wiring module 20A may have the second electrode connection member 40B, and the second wiring module 20B may have the first electrode connection member 40A. In addition, the disposition of the protrusion 71 and the engagement hole 72 may be opposite to the above example. That is, the first engagement 70A of the first wiring module 20A may have the engagement hole 72, and the second engagement 70B of the second wiring module 20B may have the protrusion 71.

In the present embodiment, the first wiring module 20A and the second wiring module 20B are combined with each other after the first wiring module 20A is attached to the first battery module 10 and the second wiring module 20B is attached to the second battery module 10.

Next, a constitution related to the electrode connection member 40 of the wiring modules 20C and 20D will be described with reference to FIG. 4. For the constitution related to the electrode connection member 40 of the wiring module 20C, “−Y direction” and “+Y direction” may be replaced in the description related to the second electrode connection member 40B of the wiring module 20B described above. For the constitution related to the electrode connection member 40 of the wiring module 20D, “−Y direction” and “+Y direction” may be replaced in the above description related to the first electrode connection member 40A of the wiring module 20A. In the present embodiment, an example of another connection module set MS is formed by the wiring module 20C and the wiring module 20D.

Next, the wiring module 20E will be described with reference to FIG. 2. The wiring module 20E is located on the most −X direction side among the plurality of wiring modules 20. The wiring module 20E includes an external connection terminal ES connected to an external component of the battery pack 1 (for example, a power supply that supplies power to a vehicle body on which the battery pack 1 is mounted).

### 5. Routing Module

Next, the routing module 80 will be described.

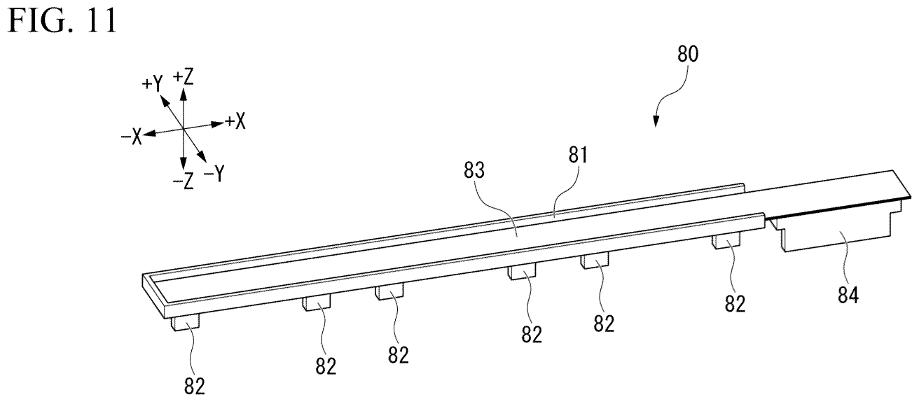

FIG. 11 is a perspective view illustrating the routing module 80. The routing module 80 is a member for collecting signals obtained from the plurality of wiring modules 20 and transmitting the collected signals to the outside. The routing module 80 includes, for example, a substrate 81, a plurality of individual connectors 82, a wiring member 83, and a joint connector 84.

### <5.1 Substrate>

The substrate 81 is a member serving as a base of the routing module 80. The substrate 81 is made of an insulating material such as a synthetic resin, and has an insulating property. The substrate 81 extends in the X direction. The substrate 81 faces the plurality of wiring modules 20 from the +Z direction side.

### <5.2 Individual Connector>

The individual connector 82 is a connection portion to be connected to each wiring module 20. The plurality of individual connectors 82 are attached to a surface of the substrate 81 on the −Z direction side. The individual connector 82 is connected to the wiring member 83. The individual connector 82 is disposed at a position corresponding to the connector 62 of each wiring module 20. The individual connector 82 is detachably connected to the connector 62 of each wiring module 20 from the +Z direction.

### <5.3 Wiring Member>

The wiring member 83 is a member having a wiring 83a (refer to FIG. 9) for transmitting a signal obtained through the individual connector 82 to the joint connector 84. The wiring member 83 is, for example, a flat wiring member. The wiring member 83 is a flexible flat cable (FFC), a flexible printed circuit (FPC), or the like. The wiring member 83 has a film shape extending along the X direction and the Y direction. The wiring 83a of the wiring member 83 is electrically connected to the plurality of wirings 53 respectively provided in the plurality of wiring modules 20 via the plurality of individual connectors 82.

### <5.4 Joint Connector>

The joint connector 84 is a connector detachably connected to a signal processing unit (for example, a monitoring unit that monitors a state of the battery pack 1) that performs signal processing related to the battery pack 1. The signal processing unit may exist as a part of the battery pack 1 or may exist as an external device of the battery pack 1. The joint connector 84 is disposed, for example, at the end of the routing module 80 on the +X direction side. The joint connector 84 transmits information obtained from the plurality of wiring modules 20 to the signal processing unit via the plurality of individual connectors 82.

### 6. Other Constitutions

Next, referring to FIG. 1 again, an insulating member 91, an end plate 92, and a coupling member 93 will be described.

### <6.1 Insulating Member>

A plurality of insulating members 91 include a first insulating member 91A and a second insulating member 91B. Each of the first insulating member 91A and the second insulating member 91B has a plate shape extending along the Y direction and the Z direction. The first insulating member 91A and the second insulating member 91B have elasticity. For example, the first insulating member 91A and the second insulating member 91B are made of an insulating material such as rubber, and have elasticity. The first insulating member 91A is disposed toward the −X direction side with respect to the plurality of battery modules 10. The second insulating member 91B is disposed toward the +X direction side with respect to the plurality of battery modules 10.

### <6.2 End Plate>

The plurality of end plates 92 include a first end plate 92A and a second end plate 92B. Each of the first end plate 92A and the second end plate 92B is a plate member extending along the Y direction and the Z direction. The first end plate 92A and the second end plate 92B are made of metal, for example, and have rigidity. The first end plate 92A is disposed toward the −X direction side with respect to the first insulating member 91A. The second end plate 92B is disposed toward the +X direction side with respect to the second insulating member 91B.

### <6.3 Coupling Member>

The plurality of coupling members 93 extend between the first end plate 92A and the second end plate 92B. The plurality of coupling members 93 couple the first end plate 92A and the second end plate 92B. When the first end plate 92A and the second end plate 92B are coupled via the coupling member 93, the first end plate 92A applies a pressing force to the plurality of battery modules 10 via the first insulating member 91A. When the first end plate 92A and the second end plate 92B are coupled via the coupling member 93, the second end plate 92B applies a pressing force to the plurality of battery modules 10 via the second insulating member 91B. Thus, the plurality of battery modules 10 are restrained.

### 7. Assembling Method

Next, a method for assembling the battery pack 1 will be described.

First, the wiring module 20 is attached to the first end 11EA and the second end 11EB of each battery module 10. As a result, a battery module assembly AS including one battery module 10 and two wiring modules 20 divided on both sides in the Y direction of the battery module 10 is obtained.

Next, the plurality of battery module assemblies AS are arranged side by side in the X direction. For example, the distal end 42A (protruding end) of the first electrode connection member 40A of one battery module assembly AS (first battery module assembly) is inserted into the distal end 42B (holder) of the second electrode connection member 40B of another battery module assembly AS (second battery module assembly). The protrusion 71 of the first battery module assembly AS is also engaged with the engagement hole 72 of the second battery module assembly AS.

Next, the plurality of insulating members 91, the plurality of end plates 92, and the plurality of coupling members 93 are attached to restrain the plurality of battery module assemblies AS in a state in which the plurality of battery module assemblies AS are stacked. Next, two routing modules 80 are attached to the plurality of battery module assemblies AS. Thus, the battery pack 1 is completed.

### 8. Modification Examples

Next, several modification examples will be described. Note that a constitution other than that described below in each modification example is the same as the constitution of the above-described embodiment.

### 8.1 First Modification Example: Cell Balance Circuit

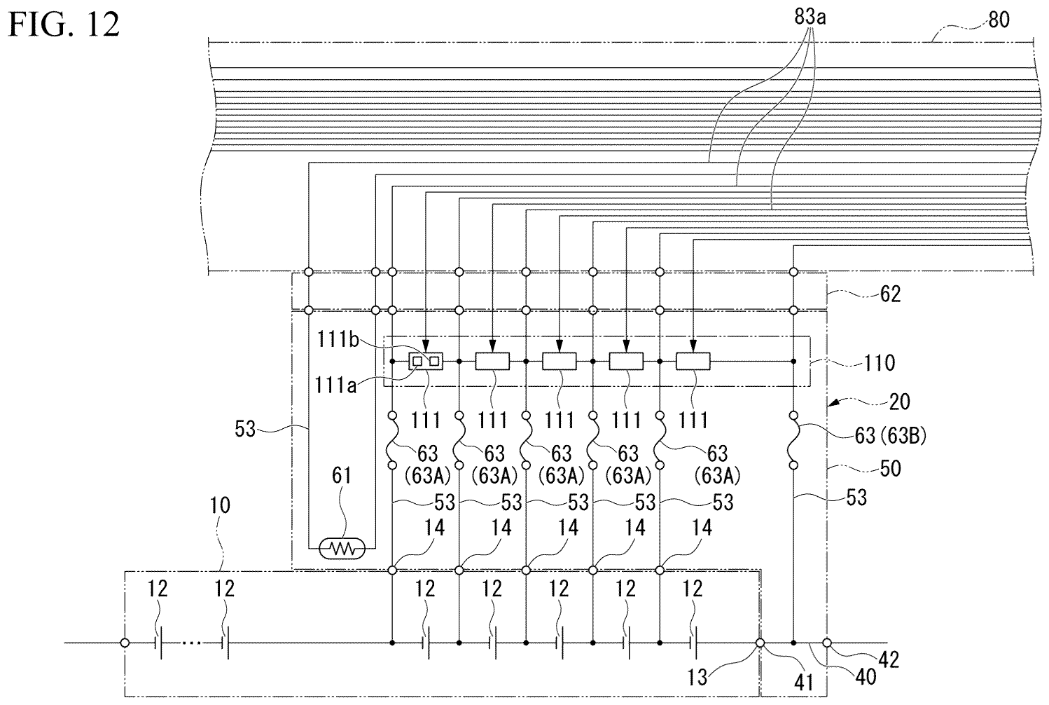

FIG. 12 is an electric circuit diagram illustrating a constitution of a wiring module 20 of a first modification example. In the present modification example, the wiring module 20 includes a cell balance circuit 110. The cell balance circuit 110 is a circuit that corrects a deviation in a storage amount of the plurality of battery cells 12. The cell balance circuit 110 includes, for example, a plurality of dischargers 111. The discharger 111 is electrically connected between two adjacent voltage detection terminals 14. The discharger 111 includes, for example, a resistor 111a and a transistor 111b. The transistor 111b is electrically connected in series to the resistor 111a. On the basis of a control signal received from the signal processing unit via the routing module 80, the transistor 111b switches between a conductive state and a non-conductive state to equalize voltages or remaining capacitance of the plurality of battery cells 12.

Each of the resistor 111a and the transistor 111b is a component used in association with the battery module 10. The discharger 111 (the resistor 111a and the transistor 111b) is provided in a main body 51 of the wiring member 50, for example. Each of the resistor 111a and the transistor 111b is an example of an “electronic component”. Note that, in a case where the discharger 111 is formed of one chip component (integrated circuit component), the chip component is an example of an “electronic component”.

### 8.2 Second Modification Example: Signal Processor

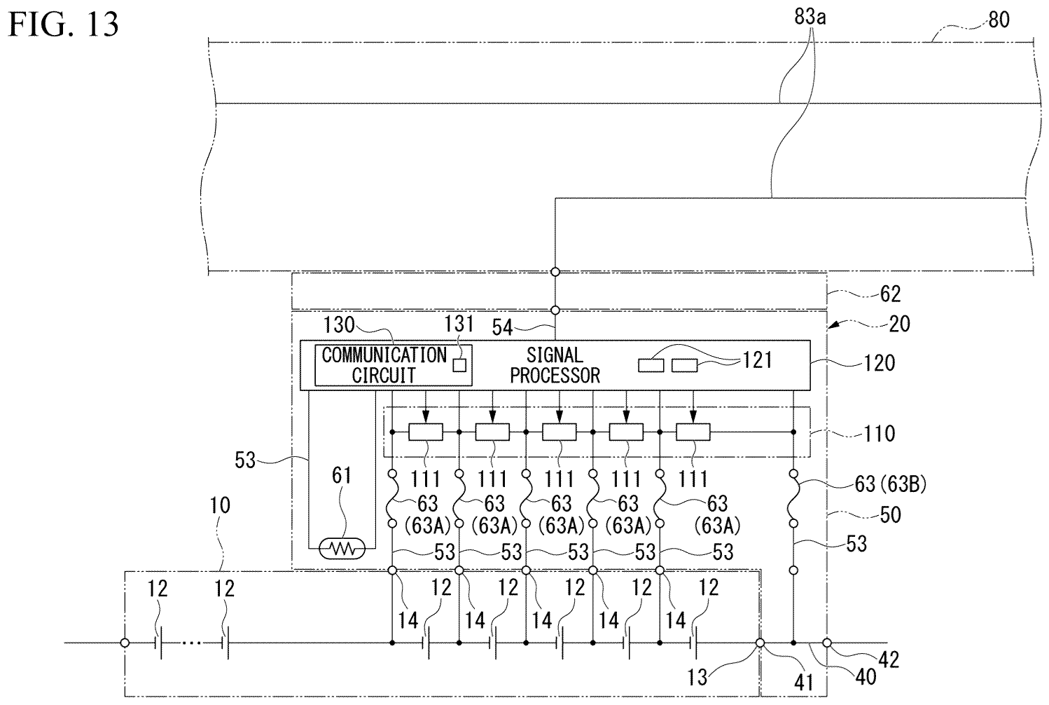

FIG. 13 is an electric circuit diagram illustrating a constitution of a wiring module 20 of a second modification example. In the present modification example, the wiring module 20 includes a signal processor 120. The signal processor 120 is a functional unit that performs processing related to a signal flowing through the wiring 53 of the wiring module 20. For example, the signal processor 120 is electrically connected between the plurality of voltage detection terminals 14 and the connector 62. The signal processor 120 includes, for example, one or more chip components (integrated circuit components) 121 that perform signal processing. The signal processor 120 (chip component 121) is provided, for example, in the main body 51 of the wiring member 50. The chip component 121 is a component used in association with the battery module 10. The chip component 121 is an example of an “electronic component”.

In the present modification example, the signal processor 120 performs processing related to a signal flowing from each voltage detection terminal 14 to the wiring 53. For example, the signal processor 120 detects a voltage value of the battery cell 12 on the basis of the magnitude of the voltage applied from each voltage detection terminal 14 to the wiring 53. The signal processor 120 generates a signal indicating the detected voltage value of the battery cell 12.

In addition, the signal processor 120 performs processing related to a signal flowing from the thermistor 61 to the wiring 53. For example, the signal processor 120 detects a temperature value of the battery cell 12 on the basis of a voltage difference between both ends of the thermistor 61. The signal processor 120 generates a signal indicating the detected temperature value of the battery cell 12.

In the present modification example, the signal processor 120 includes a communication circuit 130. The communication circuit 130 is a circuit having a function of communicating with the signal processing unit. The communication circuit 130 converts a signal (for example, a signal indicating a voltage value of the battery cell 12 and/or a signal indicating a temperature value of the battery cell 12) generated by the signal processor 120 into a signal suitable for data communication such as a packet. The communication circuit 130 transmits the signal after conversion to the signal processing unit via the connector 62 and the routing module 80 through data communication.

The communication circuit 130 includes, for example, one or more chip components (integrated circuit components) 131 that perform communication processing. The communication circuit 130 (chip component 131) is provided, for example, in the main body 51 of the wiring member 50. The chip component 131 is a component used in association with the battery module 10. The chip component 131 is an example of an “electronic component”.

In the present modification example, the signal processor 120 is connected to the connector 62 via one or more wirings 54. The number of wirings 54 between the signal processor 120 and the connector 62 is smaller than the number of wirings 53 between the signal processor 120 and the plurality of voltage detection terminals 14. The communication circuit 130 sequentially transmits signals indicating voltage values of the plurality of voltage detection terminals 14 (the plurality of battery cells 12) at different timings. The communication circuit 130 outputs the signals indicating the voltage values of the plurality of voltage detection terminals 14 (the plurality of battery cells 12) to the signal processing unit via the wirings 54 of which the number is smaller than the number of the plurality of voltage detection terminals 14.

Note that signal processing performed by the signal processor 120 is not limited to the example described above. For example, instead of/in addition to the above example, the signal processor 120 may generate a control signal for operating the cell balance circuit 110 on the basis of the magnitude of a voltage applied from each voltage detection terminal 14 to the wiring 53, and output the generated control signal to the cell balance circuit 110. In addition, the signal processing performed by the signal processor 120 may be noise removal, an averaging process, comparison with a preset threshold, or the like for a signal obtained from the electrode terminal 13, the voltage detection terminal 14, or the thermistor 61.

### 8.3 Third Modification Example: First Another Aspect of Electrode Connection Member

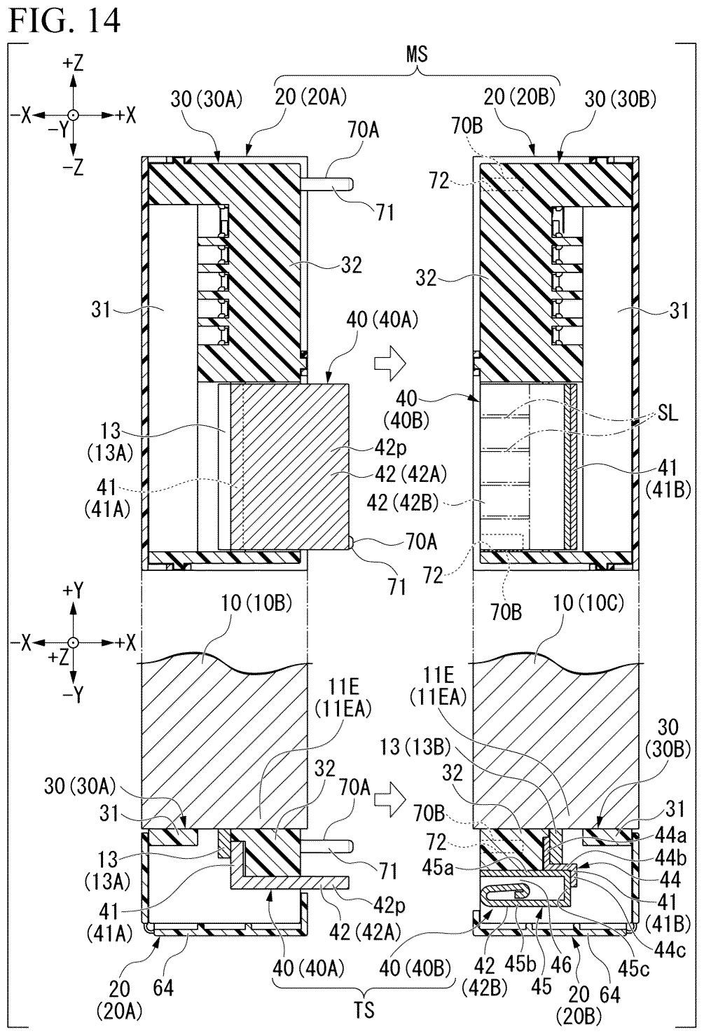

FIG. 14 is a side view illustrating the first wiring module 20A and the second wiring module 20B of the third modification example. In the present modification example, the distal end 42B of the second electrode connection member 40B includes a leaf spring member 45. The leaf spring member 45 includes a pair of clamps 45a and 45b, a base 45c, and an insertion space 46. The clamp 45a has a plate shape extending along the X direction and the Z direction. On the other hand, the clamp 45b is folded back toward the inside of the insertion space 46. The clamp 45b is elastically deformable in the Y direction. For example, the clamp 45b is elastically deformable in the Y direction with respect to the base 45c.

In the present modification example, the distal end 42A of the first wiring module 20A is press-fitted toward an innermost of the insertion space 46 while elastically deforming the clamp 45b to widen a gap (insertion space 46) between the clamps 45a and 45b in the Y direction. In this case, the distal end 42A of the first wiring module 20A is pressed from both sides in the Y direction by the clamps 45a and 45b. For example, the plate 42p of the distal end 42A of the first wiring module 20A is clamped from both sides in the Y direction by the clamps 45a and 45b.

In the present modification example, the clamp 45b has, for example, one or more (for example, a plurality of) slits SL. The plurality of slits SL are disposed apart from each other in the Z direction. Each of the plurality of slits SL extends in the +X direction from the end of the clamp 45b in the −X direction. When the slit SL is provided, even in a case where the first electrode connection member 40A is inclined with respect to the second electrode connection member 40B, the clamp 45b can be elastically deformed according to the inclination of the first electrode connection member 40A. When the clamp 45b can be elastically deformed according to the inclination of the first electrode connection member 40A, the first electrode connection member 40A and the second electrode connection member 40B are easily connected more firmly.

### 8.4 Fourth Modification Example: Second Another Aspect of Electrode Connection Member

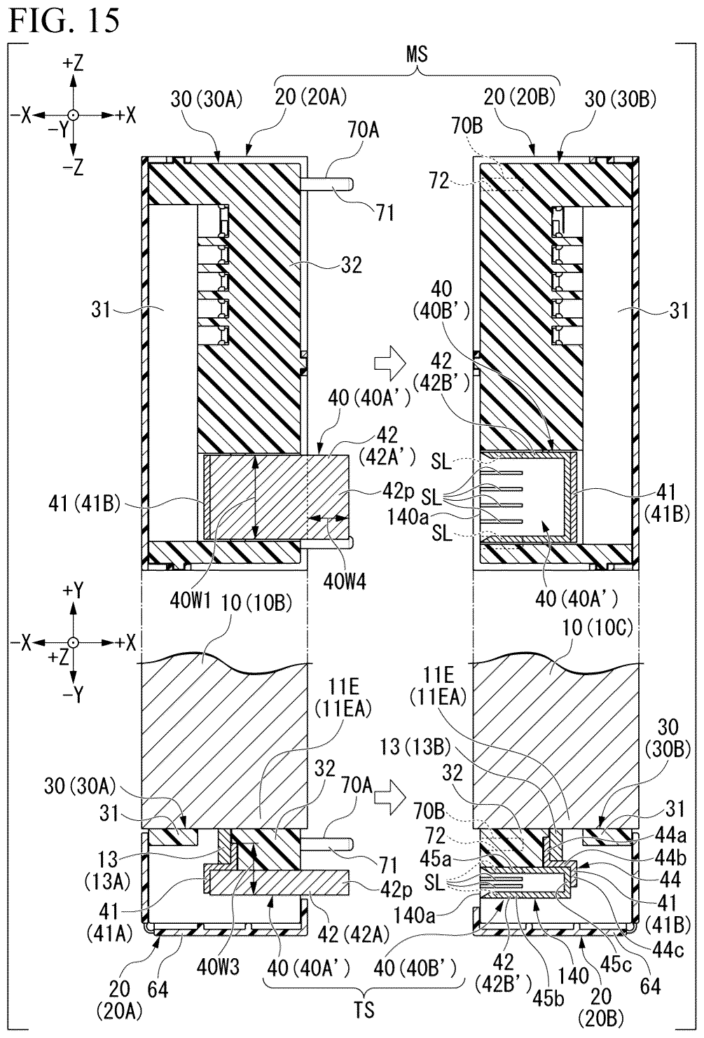

FIG. 15 is a side view illustrating a first wiring module 20A and a second wiring module 20B of a fourth modification example. The first wiring module 20A includes a first electrode connection member 40A′ as the electrode connection member 40. The first electrode connection member 40A′ is, for example, a male engaging member. The first electrode connection member 40A′ is, for example, a plate member extending along the X direction and the Z direction. The first electrode connection member 40A′ has a distal end 42A′ protruding in the +X direction. The distal end 42A′ includes a plate 42p extending along the X direction and the Z direction. The distal end 42A′ is an example of a “protruding end”.

The second wiring module 20B includes a second electrode connection member 40B′ as the electrode connection member 40. The second electrode connection member 40B′ is, for example, a female engaging member. The second electrode connection member 40B′ includes, for example, a tubular distal end 42B′ having a space into which the distal end 42A′ of the first electrode connection member 40A′ is inserted. The distal end 42B′ holds the inserted distal end 42A (protruding end) of the first wiring module 20A. The distal end 42B′ is an example of a “holder”.

In the present modification example, the distal end 42B′ has a cylinder 140 having a slot. That is, the distal end 42B′ has a plurality of slits SL. Each of the plurality of slits SL extends in the +X direction from a first end 140a which is the end of the distal end 42B′ on the −X direction side. The distal end 42B′ has the plurality of slits SL, and is thus easily elastically deformed toward the outer peripheral side of the cylinder 140. For example, the distal end 42B′ is elastically deformable at least in the Y direction. In the present modification example, the distal end 42B′ is elastically deformable in the Y direction and the Z direction. The cylinder 140 includes, for example, a pair of clamps 45a and 45b, a base 45c, and an insertion space 46.

In the present modification example, in a case where the first wiring module 20A and the second wiring module 20B are connected, the distal end 42A′ (protruding end) of the first wiring module 20A is press-fitted toward an innermost of the insertion space 46 while elastically deforming the distal end 42B′ to widen the tubular distal end 42B′ (holder) of the second wiring module 20B to the outer peripheral side (for example, to widen a gap between the clamps 45a and 45b in the Y direction). In this case, the distal end 42A′ of the first wiring module 20A is pressed from the outer peripheral side by the distal end 42B′ (for example, pressed from both sides in the Y direction by the clamps 45a and 45b). As a result, the first wiring module 20A and the second wiring module 20B are physically and electrically connected. The plate 42p of the distal end 42A′ of the first wiring module 20A is clamped from both sides in the Y direction by the clamps 45a and 45b.

### 9. Advantages

<9.1 Advantages from First Viewpoint>

As a comparative example, in a battery pack in which a plurality of battery modules are arranged side by side, a constitution will be considered in which each battery module has a plurality of detection terminals, and an individual electrical connection component is attached to each of the plurality of detection terminals. In the constitution of the comparative example, the work of attaching the individual electrical connection component to each of the plurality of detection terminals is complicated, and the assembling workability of the battery pack may deteriorate. This tendency can be remarkable in a case where the number of battery modules included in one battery pack increases as the capacity of the battery pack increases.

On the other hand, in the present embodiment, the wiring module 20 includes an insulating substrate 30 and a wiring member 50. In a case of assuming that a direction in which the plurality of battery modules 10 are arranged is a first direction, and that a direction different from the first direction is a second direction, the substrate 30 is disposed to face the first end 11EA in the second direction of one battery module 10 included in the plurality of battery modules 10. The wiring member 50 includes a main body 51 supported by the substrate 30 and a plurality of terminal connection portions 52A which mutually branch and extend from the main body 51 and are respectively connected to a plurality of detection terminals (for example, voltage detection terminals 14) provided at the first end 11EA of the battery module 10. According to such a constitution, even in a case where the battery module 10 has a plurality of detection terminals, electrical connection to the plurality of detection terminals can be realized by using one wiring member 50. When the electrical connection to the plurality of detection terminals can be realized by using one wiring member 50, the assembling workability of the battery pack 1 can be improved as compared with a case where an individual electrical connection component is attached to each of the plurality of detection terminals.

In the present embodiment, the plurality of voltage detection terminals 14 includes three or more detection terminals disposed in parallel. The plurality of terminal connection portions 52A include three or more terminal connection portions 52A respectively connected to the three or more detection terminals. According to such a constitution, even in a case where three or more detection terminals disposed in parallel exist, electrical connection to the three or more detection terminals can be easily realized.

In the present embodiment, the substrate 30 has a plurality of partition walls 34 that electrically insulate the plurality of detection terminals from each other. The plurality of terminal connection portions 52A extend separately inside a plurality of regions R defined by the plurality of partition walls 34. According to such a constitution, the plurality of terminal connection portions 52A can extend separately inside the plurality of regions R defined by the plurality of partition walls 34. When the plurality of terminal connection portions 52A can extend separately inside the plurality of regions R, insulation between the plurality of terminal connection portions 52A can be secured at a higher level.

In the present embodiment, the plurality of detection terminals are arranged side by side in a third direction different from the first direction and the second direction. The plurality of terminal connection portions 52A are disposed to respectively face the plurality of detection terminals from the first direction. According to such a constitution, the direction in which the plurality of detection terminals are arranged is different from the direction in which the plurality of terminal connection portions 52A are connected to the plurality of detection terminals. When these directions are different from each other, for example, a gap between the plurality of detection terminals can be reduced as compared with a case where the detection terminal and the terminal connection portion 52A are connected in the third direction. When the gap between the plurality of detection terminals can be reduced, the battery pack 1 can be easily downsized.

In the present embodiment, the main body 51 of the wiring member 50 is disposed to face the substrate 30 from the second direction. The plurality of terminal connection portions 52A are bent from the main body 51 and disposed to respectively face the plurality of detection terminals from the first direction. According to such a constitution, the main body 51 having an area larger than that of the terminal connection portion 52A can be disposed in the first direction. When the main body 51 can be disposed in the first direction, the battery pack 1 can be easily downsized.

In the present embodiment, the wiring module 20 includes the electrode connection member 40. The electrode connection member 40 includes a basal end 41 electrically connected to the electrode terminal 13 of the battery module 10 and a distal end 42 electrically connected to the electrode terminal 13 of another battery module 10. The wiring member 50 further includes a terminal connection portion 52B connected to the electrode connection member 40. According to such a constitution, the terminal connection portion 52B connected to the electrode connection member 40 and the plurality of terminal connection portions 52A connected to the plurality of detection terminals can be implemented by using one wiring member 50. When the terminal connection portion 52B and the plurality of terminal connection portions 52A can be implemented by using one wiring member 50, the assembling workability of the battery pack 1 can be further improved.

In the present embodiment, the wiring module 20 further includes a thermistor 61 for detecting a temperature related to the battery module 10. The wiring member 50 further includes a thermistor connection portion 52C connected to the thermistor 61. According to such a constitution, the thermistor connection portion 52C and the plurality of terminal connection portions 52A can be implemented by using one wiring member 50. When the thermistor connection portion 52C and the plurality of terminal connection portions 52A can be implemented by using one wiring member 50, the assembling workability of the battery pack 1 can be further improved.

In the present embodiment, the wiring module 20 further includes a connector 62 that is supported by the substrate 30 and to which the routing module 80 is detachably connected. The main body 51 is connected to the connector 62. According to such a constitution, it is possible to improve the assembling workability of the battery pack 1 inside the wiring module 20 attached to each battery module 10.

In the first viewpoint, the wiring member 50 does not have to be provided with an electronic component. The electrode terminals 13 of the plurality of battery modules 10 may be connected by using a connection structure using bolt fastening.

<9.2 Advantages from Second Viewpoint>

As a comparative example, in a battery pack including a plurality of battery modules, a constitution will be considered in which electronic components used in association with each battery module are collectively disposed in a signal processing unit (for example, a monitoring device) of the battery pack. In the constitution of this comparative example, a wiring between each battery module and the signal processing unit is complicated, and/or a size of the signal processing unit (for example, a monitoring device) tends to be increased due to the electronic components being collectively disposed, so that it may be difficult to reduce the size of the battery pack. This tendency can be remarkable in a case where the number of battery modules included in one battery pack increases as the capacity of the battery pack increases.

On the other hand, in the present embodiment, the wiring module 20 includes an insulating substrate 30, a wiring member 50, and an electronic component. In a case of assuming that a direction in which the plurality of battery modules 10 are arranged is a first direction, and that a direction different from the first direction is a second direction, the substrate 30 is disposed to face the first end 11EA in the second direction of one battery module 10 included in the plurality of battery modules 10. The wiring member 50 includes a main body 51 supported by the substrate 30, and a terminal connection portion 52A (or a terminal connection portion 52B) extending from the main body 51 and connected to a detection terminal provided at the first end 11EA of the battery module 10. The electronic component is provided on the wiring member 50 and used in association with the battery module 10. According to such a constitution, the electronic component is disposed by using the wiring module 20, so that the wiring between the wiring module 20 and the signal processing unit (for example, a monitoring device) can be simplified, and/or a large number of electronic components can be suppressed from being collectively disposed in the signal processing unit (for example, a monitoring device). As a result, the battery pack 1 can be easily downsized. Note that the simplification of the wiring indicates, for example, reduction in the number of wirings, simplification of a wiring layout, or deletion or reduction of a protection function.

In the present embodiment, the electronic component is electrically connected to the detection terminal of the battery module 10 via the terminal connection portion 52A (or the terminal connection portion 52B). According to such a constitution, processing or an operation related to a state of the detection terminal of the battery module 10 can be performed near the battery module 10. When such processing or operation can be performed near the battery module 10, the wiring between the wiring module 20 and the signal processing unit can be further simplified. As a result, the battery pack 1 can be more easily downsized.

In the present embodiment, the wiring module 20 further includes a connector 62 to which the routing module 80 of the battery pack 1 is detachably connected. The electronic component is electrically connected between the terminal of the battery module 10 and the connector 62. According to such a constitution, since the wiring between the wiring module 20 and the signal processing unit can be simplified, the routing module 80 can be simplified. The simplification of the wiring module indicates, for example, reduction of the number of wirings in the wiring module, simplification of a wiring layout, or deletion or reduction of a protection function.

In the present embodiment, the main body 51 of the wiring member 50 is disposed to face the substrate 30 from the second direction. The terminal connection portion 52A is bent from the main body 51 and disposed to face the detection terminal of the battery module 10 from the first direction. The electronic component is provided in the main body 51 of the wiring member 50. According to such a constitution, the electronic component is disposed by using the second direction in which a spatial margin is likely to occur as compared with the first direction, so that it is easy to suppress an increase in size of the wiring module 20 even in a case where the electronic component is provided in the wiring module 20. In addition, since the electronic component is provided in the main body 51, the electronic component can be stably mounted as compared with the case where the electronic component is provided in the terminal connection portion 52A.

In the present embodiment, the electronic component is the fuse component 63 electrically connected to the detection terminal of the battery module 10. According to such a constitution, since a protection function related to a state of the detection terminal of the battery module 10 can be provided near the battery module 10, the wiring between the wiring module 20 and the signal processing unit can be more easily simplified.

In the present embodiment, the wiring module 20 further includes a cell balance circuit 110 provided in the wiring member 50. The electronic component is a component (for example, the resistor 111a or the transistor 111b) included in the cell balance circuit 110. According to such a constitution, since the cell balance circuit 110 corresponding to each battery module 10 can be provided near the battery module 10, the wiring between the wiring module 20 and the signal processing unit can be more easily simplified.

In the present embodiment, the wiring module 20 further includes an information processor 120 that is provided in the wiring member 50 and performs processing related to a signal obtained from the detection terminal of the battery module 10. The electronic component is a component included in the information processor 120. According to such a constitution, since the signal processing corresponding to each battery module 10 can be realized near the battery module 10, the wiring between the wiring module 20 and the signal processing unit can be more easily simplified.

In the present embodiment, the wiring module 20 further includes a communication circuit 130 that converts a signal obtained from the detection terminal of the battery module 10 and transmits a signal after conversion. The electronic component is a component included in the communication circuit 130. According to such a constitution, information detected inside the wiring module 20 can be transmitted through data communication. Therefore, the number of wirings between the wiring module 20 and the signal processing unit can be easily reduced.

In the second viewpoint, the wiring member 50 does not have to include the plurality of terminal connection portions 52A that mutually branch. The electrode terminals 13 of the plurality of battery modules 10 may be connected by using a connection structure using bolt fastening.

<9.3 Advantages from Third Viewpoint>

As a comparative example, in a battery pack in which a plurality of battery modules are arranged in the first direction, a constitution will be considered in which a connection structure is implemented through bolt fastening from a direction different from the first direction in a case where electrodes of the plurality of battery modules are connected to each other. In the constitution of the comparative example, the work of connecting the electrodes of the plurality of battery modules through bolt fastening is complicated, and the assembling workability of the battery pack may deteriorate. This tendency can be remarkable in a case where the number of battery modules included in one battery pack increases as the capacity of the battery pack increases.

On the other hand, in the present embodiment, the connection module set MS is a member set used for the battery pack 1 including the first battery module 10 and the second battery module 10 adjacent to the first battery module 10 in the first direction. The connection module set MS includes a first wiring module 20A and a second wiring module 20B. The first wiring module 20A includes an insulating first substrate 30A and a first electrode connection member 40A supported by the first substrate 30A. The first substrate 30A is disposed to face the first end 11EA of the first battery module 10. The first electrode connection member 40A includes a basal end 41A electrically connected to the first electrode terminal 13 of the first battery module 10 and a distal end 42A (protruding end) protruding in the first direction. The second wiring module 20B includes an insulating second substrate 30B and a second electrode connection member 40B supported by the second substrate 30B. The second substrate 30B is disposed to face the first end 11EA of the second battery module 10. The second electrode connection member 40B includes a basal end 41B electrically connected to the second electrode terminal 13 of the second battery module 10 and a distal end 42B (holder) into which the distal end 42A (protruding end) of the first electrode connection member 40A is inserted and held. According to such a constitution, since the two battery modules 10 are arranged side by side in the first direction, the first electrode connection member 40A is held by the second electrode connection member 40B. When such a holding structure is provided, the assembling workability of the battery pack 1 can be improved as compared with a case where such a holding structure is not provided.

In the present embodiment, the distal end 42B (holder) of the second electrode connection member 40B has a portion elastically deformable in a direction intersecting the first direction, and holds the distal end 42A (protruding end) of the first electrode connection member 40A. According to such a constitution, at least a part of the distal end 42B (holder) of the second electrode connection member 40B is elastically deformed, and thus the distal end 42A of the first electrode connection member 40A is more firmly held. When the distal end 42A of the first electrode connection member 40A is more firmly held, the assembling workability of the battery pack 1 is more easily improved. In the present disclosure, the “direction intersecting the first direction (for example, the X direction)” is not limited to the second direction (for example, the Y direction), and may be the third direction (for example, the Z direction).

In the present embodiment, the distal end 42B (holder) of the second electrode connection member 40B is elastically deformable at least in the second direction, and includes clamps 45a and 45b that clamp the distal end 42A (protruding end) of the first electrode connection member 40A from both sides in the second direction. According to such a constitution, the distal end 42A (protruding end) of the first electrode connection member 40A is clamped and hardly removed, so that the assembling workability of the battery pack 1 can be more easily improved.

In the present embodiment, in a case where a direction intersecting the first direction and the second direction is defined as the third direction, the distal end 42A (protruding end) of the first electrode connection member 40A includes a plate 42p extending along the first direction and the third direction. The clamps 45a and 45b clamp the plate 42p from both sides in the second direction. According to such a constitution, it is possible to secure a large connection structure between the distal end 42A of the first electrode connection member 40A and the clamps 45a and 45b while suppressing an increase in the width of the battery pack 1 in the Y direction.

In the present embodiment, the distal end 42B (holder) of the second electrode connection member 40B includes a cylinder 140. The cylinder 140 includes a first end 140a on the first wiring module 20A side and a plurality of slits SL each extending from the first end 140a toward a direction away from the first wiring module 20A. According to such a constitution, it is possible to realize a structure in which the distal end 42A (protruding end) of the first electrode connection member 40A is held by the cylinder 140 having the slit SL.

In the present embodiment, one of the first substrate 30A and the second substrate 30B includes a protrusion 71 protruding in the first direction. The other of the first substrate 30A and the second substrate 30B includes an engagement hole 72 into which the protrusion 71 is inserted. According to such a constitution, in addition to the connection between the first electrode connection member 40A and the second electrode connection member 40B, the first substrate 30A and the second substrate 30B are engaged with each other, so that more stable assembling work can be performed.

In the present embodiment, the first wiring module 20A and the second wiring module 20B are combined with each other after the first wiring module 20A is attached to the first battery module 10 and the second wiring module 20B is attached to the second battery module 10. According to such a constitution, the first electrode connection member 40A and the second electrode connection member 40B can be connected as a part of the work of arranging the plurality of battery modules 10 in the first direction.

In the third viewpoint, the wiring member 50 does not have to include the plurality of terminal connection portions 52A that mutually branch. Further, the wiring member 50 does not have to be provided with an electronic component.

The embodiment and the plurality of modification examples have been described above. However, the embodiment and the modification examples are not limited to the examples described above. For example, the above-described modification examples may be implemented in combination with each other. In the above-described embodiment, the battery module 10 is a bipolar battery module. Alternatively, the battery module 10 may be a monopolar battery module. The first wiring module 20A does not have to include the substrate 30. That is, the first electrode connection member 40A may be directly attached to the battery module 10. The second wiring module 20B does not have to include the substrate 30. That is, the second electrode connection member 40B may be directly attached to the battery module 10.

While preferred embodiments of the invention have been described and illustrated above, it should be understood that these are exemplary examples of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### INDUSTRIAL APPLICABILITY

According to the present disclosure, it is possible to provide a connection module set, an electrode connection member set, and a battery pack capable of improving assembling workability of the battery pack.

### REFERENCE SIGNS LIST

1 Battery pack
10 Battery module
11 Case
12 Battery cell
13 Electrode terminal (detection terminal)
13A Positive electrode terminal (detection terminal)
13B Negative electrode terminal (detection terminal)
14 Voltage detection terminal (detection terminal)
20, 20A, 20B, 20C, 20D, 20E Wiring module
30 Substrate
30A First substrate
30B Second substrate
34 Partition wall
40 Electrode connection member
40A First electrode connection member
40B Second electrode connection member
41 Basal end of electrode connection member
41A Basal end of first electrode connection member
41B Basal end of second electrode connection member
42 Distal end of electrode connection member
42A Distal end (protruding end) of first electrode connection member
42B Distal end (holder) of second electrode connection member
45a, 45b Clamp
50 Wiring member
51 Main body
52A, 52B Terminal connection portion
53 Wiring
61 Thermistor
62 Connector
63 Fuse component
110 Cell balance circuit
111 Discharger (electronic component)
111a Resistor (electronic component)
111b Transistor (electronic component)
120 Information processor
121 Chip component (electronic component)
130 Communication circuit
131 Chip component (electronic component)

What is claimed is:

1. A connection module set that is a member set used for a battery pack including a first battery module and a second battery module adjacent to the first battery module in a first direction, the connection module set comprising:
a first connection module including an insulating first substrate disposed to face an end of the first battery module in a second direction in a case where the second direction is a direction intersecting the first direction, and a first electrode connection member supported by the first substrate, the first electrode connection member including a basal end electrically connected to a first electrode terminal of the first battery module and a protruding end protruding in the first direction; and
a second connection module including an insulating second substrate disposed to face an end of the second battery module in the second direction, and a second electrode connection member supported by the second substrate, the second electrode connection member including a basal end electrically connected to a second electrode terminal of the second battery module and a holder into which the protruding end of the first electrode connection member of the first connection module is inserted from the first direction and held.

2. The connection module set according to claim 1, wherein
the holder has a portion elastically deformable in a direction intersecting the first direction and holds the protruding end.

3. The connection module set according to claim 1, wherein
the holder includes a clamp elastically deformable at least in the second direction and clamping the protruding end from both sides in the second direction.

4. The connection module set according to claim 3, wherein
in a case where a direction intersecting the first direction and the second direction is a third direction,
the protruding end includes a plate extending along the first direction and the third direction, and
wherein the clamp clamps the plate from both sides in the second direction.

5. The connection module set according to claim 1, wherein
the holder includes a cylinder, and
the cylinder includes a first end on a side of the first connection module and a plurality of slits each extending from the first end toward a direction away from the first connection module.

6. The connection module set according to claim 1, wherein
one of the first substrate and the second substrate includes a protrusion protruding in the first direction, and
an other of the first substrate and the second substrate includes an engagement hole into which the protrusion is inserted from the first direction.

7. The connection module set according to claim 1, wherein
the first connection module and the second connection module are combined with each other after the first connection module is attached to the first battery module and the second connection module is attached to the second battery module.

8. An electrode connection member set that is a member set used for a battery pack including a first battery module and a second battery module adjacent to the first battery module in a first direction, the electrode connection member set comprising:
a first electrode connection member including a basal end overlapping one end of the first battery module when viewed from a second direction in a case where the second direction is a direction intersecting the first direction, and electrically connected to a first electrode terminal of the first battery module, and a protruding end protruding in the first direction; and
a second electrode connection member including a basal end overlapping one end of the second battery module when viewed from the second direction and electrically connected to a second electrode terminal of the second battery module, and a holder that has a portion elastically deformable in a direction intersecting the first direction and into which the protruding end of the first electrode connection member is inserted from the first direction and held.

9. A battery pack comprising:
a first battery module;
a second battery module adjacent to the first battery module in a first direction;
a first connection module including an insulating first substrate disposed to face an end of the first battery module in a second direction in a case where the second direction is a direction intersecting the first direction, and a first electrode connection member supported by the first substrate, the first electrode connection member including a basal end electrically connected to a first electrode terminal of the first battery module and a protruding end protruding in the first direction; and
a second connection module including an insulating second substrate disposed to face an end of the second battery module in the second direction, and a second electrode connection member supported by the second substrate, the second electrode connection member including a basal end electrically connected to a second electrode terminal of the second battery module, and a holder into which the protruding end of the first electrode connection member of the first connection module is inserted from the first direction and held.
